(19) United States
(12) Patent Application Publication
(10) Pub. No.: US 2021/0129149 A1
(43) Pub. Date: May 6, 2021

(54) MICROFLUIDIC DEVICE AND METHOD OF MANIPULATING PARTICLES IN A FLUID SAMPLE BASED ON AN ACOUSTIC TRAVELLING WAVE USING MICROFLUIDIC DEVICE

(71) Applicant: SINGAPORE UNIVERSITY OF TECHNOLOGY AND DESIGN, Singapore (SG)

(72) Inventors: Ye Ai, Singapore (SG); David Collins, Melbourne (AU); Richard O'Rorke, Singapore (SG)

(21) Appl. No.: 17/074,689

(22) Filed: Oct. 20, 2020

(30) Foreign Application Priority Data
Nov. 6, 2019 (SG) 10201910320P

(51) Int. Cl. B01L 3/00

(52) U.S. Cl. CPC B01L 3/502769; B01L 2400/0436

(57) ABSTRACT

A microfluidic device includes a substrate and a microfluidic channel, wherein the microfluidic channel is configured to form a fluid pathway for allowing a fluid sample comprising particles to flow along the microfluidic channel; and a single transducer provided on the substrate for producing an acoustic travelling wave that propagates on the substrate surface towards an interaction region associated with the microfluidic channel as the fluid sample is flowing through the microfluidic channel. The microfluidic channel comprises three channel portions having three orientations, respectively, that are different from each other with respect to a direction of the propagation path of the travelling acoustic wave in the interaction region, the three channel portions arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

### CROSS-REFERENCE TO RELATED APPLICATION

This application claims the benefit of priority of Singapore Patent Application No. 10201910320P, filed on 6 Nov. 2019, the content of which being hereby incorporated by reference in its entirety for all purposes.

### TECHNICAL FIELD

The present invention generally relates to a microfluidic device, a method of forming the microfluidic device and a method of manipulating particles (e.g., cells) in a fluid sample based on an acoustic travelling wave using the microfluidic device.

### BACKGROUND

Microscale acoustics have a wide range of biomedical applications where cell manipulation is required. Particles including cells, spheroids and droplets may be patterned, sorted, separated, concentrated, focused and otherwise manipulated with application of biocompatible acoustic forces. The acoustic radiation force is a phenomenon of nonlinear acoustics that can be used to translate objects at the microscale. Surface acoustic waves (SAW) are a particularly useful set of actuation wave modes as they can readily define the locations where acoustic forces are realized with potential for multiple addressable transducers, create fields that evolve spatially with different transducer designs and contain nodal positions that can be defined by the applied phase or in select sub-regions along the propagation direction. In conventional techniques, to create time-averaged periodic acoustic radiation forces and a non-uniform acoustic potential gradient either two sets of transducers are used to create an interference pattern, a wave reflector is used to reflect an incoming wave so that it interferes with outgoing one or an entire microchannel is vibrated so that two or more sides act as emitters of acoustic waves. For example, one technique uses standing wave SAW imposed by two transducers external to the microchannel, with a microchannel that is oriented parallel to the SAW nodes on the substrate. However, the conventional techniques require precise alignment of the microchannel with respect to the transducers such as parallel or perpendicular to the transducers to achieve the desired function. Further, by employing standing waves in conventional techniques, the acoustic field gradients are limited to sinusoidal distributions.

In other cases, interactions between acoustic waves and microfluidic channels may generate microscale interference patterns with the application of a traveling SAW, effectively creating standing wave patterns with a traveling wave. Forces arising from this interference can be utilized for precise manipulation of micron-sized particles including biological cells. The patterns that have been produced with this method, however, have been limited to straight lines and grids from flat channel walls, and where the spacing resulting from this interference has not previously been comprehensively explored.

A need therefore exists to provide a microfluidic device that seeks to overcome, or at least ameliorate, one or more of the deficiencies of conventional microfluidic devices for acoustic particle manipulation and an improved microfluidic device for acoustic particle manipulation. It is against this background that the present invention has been developed.

### SUMMARY

According to a first aspect of the present invention, there is provided a microfluidic device comprising:

a substrate having a substrate surface;

a microfluidic channel provided on the substrate surface, wherein the microfluidic channel is configured to form a fluid pathway for allowing a fluid sample comprising particles to flow along the microfluidic channel; and

a single transducer provided on the substrate for producing an acoustic travelling wave that propagates on the substrate surface towards an interaction region associated with the microfluidic channel as the fluid sample is flowing through the microfluidic channel,

wherein the microfluidic channel comprises at least three channel portions having three orientations, respectively, that are different from each other with respect to a direction of a propagation path of the travelling acoustic wave in the interaction region, the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

According to a second aspect of the present invention, there is provided a method of forming a microfluidic device for acoustic particle manipulation, the method comprising:

providing a substrate having a substrate surface;

providing a microfluidic channel on the substrate surface, wherein the microfluidic channel is configured to form a fluid pathway for allowing a fluid sample comprising particles to flow along the microfluidic channel; and providing a single transducer on the substrate for producing an acoustic travelling wave that propagates on the substrate surface towards an interaction region associated with the microfluidic channel as the fluid sample is flowing through the microfluidic channel,

wherein the microfluidic channel comprises at least three channel portions having three orientations, respectively, that are different from each other with respect to a direction of a propagation path of the travelling acoustic wave in the interaction region, wherein the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

According to a third aspect of the present invention, there is provided a method of manipulating particles in a fluid sample based on a traveling acoustic wave using the microfluidic device as described above according to the first aspect of the present invention, the method comprising:

flowing the fluid sample comprising particles through the microfluidic channel of the microfluidic device to manipulate the fluid sample, including the particles therein;

generating an acoustic travelling wave using the single transducer that propagates on the substrate surface towards an interaction region of the microfluidic channel as the fluid sample flows through the microfluidic channel such that the at least three channel portions produces fluid wavefronts based on substrate-propagated acoustic waves such that the fluid wavefronts and subsequent substrate-propagated acoustic wavefronts interfere with one another to generate periodic acoustic force fields in the fluid sample; and

patterning the particles based on the periodic acoustic force fields in the interaction region of the microfluidic channel.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIGS. 1A-1C depict schematic and tops views of a microfluidic device, according to various embodiments of the present invention;

FIG. 2 depicts a schematic flow diagram of a method of forming a microfluidic device, according to various embodiments of the present invention, such as the microfluidic device as described with reference to FIG. 1;

FIG. 3 depicts a schematic flow diagram of a method of manipulating particles in a fluid sample based on a traveling acoustic wave, according to various embodiments, using the microfluidic device as described with reference to FIG. 1;

FIGS. 4A-4B illustrate channel features, including curved ones, in the propagation path of a SAW used to create particle patterns, according to various example embodiments of the present invention;

FIGS. 5A-5B show diagrams illustrating field emitted from a finite transducer width, according to various example embodiments of the present invention;

FIGS. 6A-6B show conceptual diagrams of the interference models between a SAW wavefront and a fluid wavefront results in an ellipsoidal interference pattern, according to various example embodiments of the present invention;

FIG. 7 illustrates periodic spacing near a channel interface, according to various example embodiments of the present invention;

FIG. 8 shows images illustrating first order transient acoustic pressures, according to various example embodiments of the present invention;

FIGS. 9A-9B illustrate plots of the Fresnel-Kirchoff parameter u and diffraction coefficient, respectively;

FIG. 10A illustrates acoustic field in the x-z plane orthogonal to channel wall in the fluid domain, according to various example embodiments of the present invention;

FIG. 10B shows plots of force vector field F^{rad} for various wall orientations, according to various example embodiments of the present invention;

FIG. 10C illustrates each contour plot mapped, according to various example embodiments of the present invention;

FIG. 10D illustrates the fringe spacing (from minima to minima) matches the derived equations, according to various example embodiments of the present invention;

FIGS. 11A-11C illustrate periodicity of interference patterns around a channel wall arranged at various orientations with respect to a direction of a propagation path of an acoustic travelling wave, according to various example embodiments of the present invention;

FIGS. 12A-12C illustrate periodic spacing in the vicinity of a circular feature, according to various example embodiments of the present invention;

FIG. 12D shows graphs illustrating the mean value taken across three separate experiments for channel interface orientations with 10° increments with respect to the direction of the propagation path of the acoustic travelling wave, and three representative optical intensity profiles measured from the edge of the interface, according to various example embodiments of the present invention;

FIG. 13A shows representative simulation plots and periodic fringe spacing plots, according to various example embodiments of the present invention;

FIG. 13B shows a graph illustrating simulated values of λ_{θ} relative to λ_{SAW}, according to various example embodiments of the present invention;

FIGS. 14A-14B show graphs illustrating the effect of sound speed on transition between equations derived according to various example embodiments of the present invention;

FIGS. 15A-15B show plots illustrating that the evolved time-averaged field around an object can be composed of the sum of intersection ellipsoids from every point on the object surface according the Huygens-Fresnel principle according to various example embodiments of the present invention;

FIGS. 16-17 show conceptual diagrams illustrating the intersection of a fluid wavefront and a SAW wavefront according to various example embodiments of the present invention;

FIGS. 18A-18B show conceptual diagrams of the interference models between a SAW wavefront and a fluid wavefront, according to various example embodiments of the present invention;

FIGS. 19A-19B show conceptual diagrams illustrating the intersection of a fluid wavefront and a SAW wavefront according to various example embodiments of the present invention;

FIG. 20 shows yet another conceptual diagram illustrating the intersection of a fluid wavefront and a SAW wavefront according to various example embodiments of the present invention;

FIG. 21 shows a diagram illustrating a channel wall having a radius of curvature, according to various example embodiments of the present invention; and

FIG. 22 shows images illustrating the acoustic pressure distribution in microfluidic channels over the full range of possible channel orientations with a SAW wavelength equal to half the channel width, according to various example embodiments of the present invention.

### DETAILED DESCRIPTION

Various embodiments of the present invention provide a microfluidic device, a method of forming the microfluidic device and a method of manipulating particles (e.g., different types of particles, such as cells) in a fluid sample based on an acoustic traveling wave using the microfluidic device.

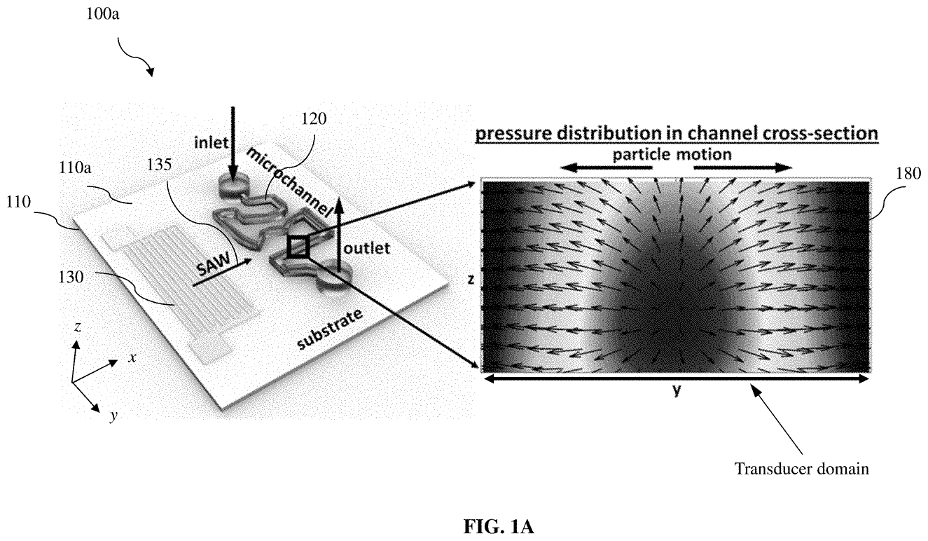

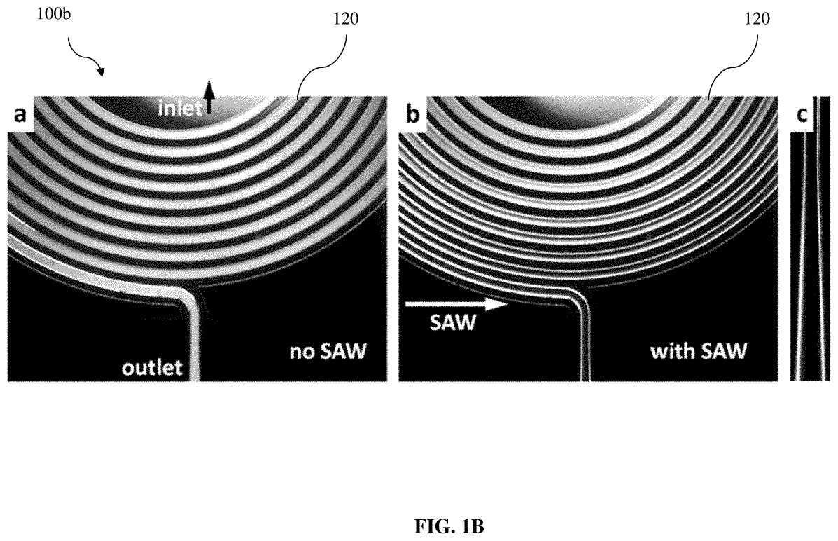

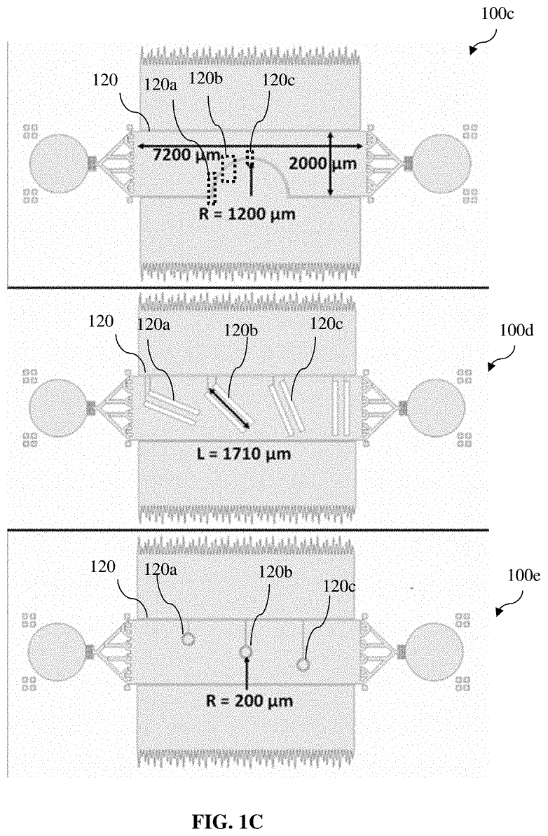

FIG. 1A depicts a schematic drawing of a microfluidic device 100a according to various embodiments of the present invention, and more particularly, for manipulating particles (e.g., cells) in a fluid sample based on an acoustic traveling wave. The microfluidic device 100 comprises: a substrate 110 having a substrate surface 110a; a microfluidic channel 120 provided on the substrate surface 110a, wherein the microfluidic channel is configured to form a fluid pathway for allowing a fluid sample comprising particles to flow along the microfluidic channel; and single transducer 130 provided on the substrate for producing an acoustic travelling wave that propagates on the substrate surface towards an interaction region associated with the microfluidic channel as the fluid sample is flowing through the microfluidic channel, wherein the microfluidic channel comprises at least three channel portions having three orientations, respectively, that are different from each other with respect to a direction 135 of a propagation path of the travelling acoustic wave in the interaction region, the at least three channel portions are arranged to produce fluid wavefronts based on substrate-propagated acoustic waves such that the fluid wavefronts and subsequent substrate-propagated acoustic wavefronts interfere with one another to generate periodic acoustic force fields (having regular spacing or intervals) in the fluid sample (in the interactive region) for manipulating the particles.

The image 180 in FIG. 1A shows an exemplary pressure field in a narrow channel oriented parallel to the direction of the propagation path of the travelling acoustic wave according to various embodiments of the present invention. It can be understood by a person skilled in the art that for illustration purpose only and without limitation, FIG. 1A illustrates an example configuration (e.g., first example configuration) of the microfluidic device 100 where the microfluidic channel 120 comprises a plurality of channel portions having a variety of different orientations with respect to the direction 135 of the propagation path of the travelling acoustic wave. In various embodiments, the microfluidic channel comprising the at least three channel portions having three orientations is arranged over the substrate, at any orientation with respect to the incoming travelling wavefronts of the acoustic travelling wave. As illustrated in FIG. 1A, the microfluidic channel comprises a plurality of channel portions having a plurality of orientations which may be arranged in the propagation path of the acoustic travelling wave to produce a desired acoustic field in the microfluidic channel for particle micromanipulation. In other words, the microfluidic channel comprises a plurality of number of orientations. The channel portions of the microfluidic channel may comprise configurations, including but not limited, straight, ellipsoid, serpentine and curved.

As illustrated, in various embodiments, the at least three channel portions comprise a first channel portion which is a channel wall of the microfluidic channel arranged parallel (e.g., at an angle of 0°) with respect to the direction 135 of the propagation path of the travelling acoustic wave, a second channel portion which is a channel wall of the microfluidic channel arranged perpendicular (e.g., at an angle of 90°) with respect to the direction 135 of the propagation path of the travelling acoustic wave, and a third channel portion which is a channel wall of the microfluidic channel arranged at an angle which is non-parallel and non-perpendicular with respect to the direction 135 of the propagation path of the travelling acoustic wave. It will be appreciated by a person skilled in the art that the microfluidic device 100 is not limited to the microfluidic channel 120 comprising the configuration as illustrated in FIG. 1A, and in another example configuration (e.g., second example configuration), a microfluidic device 100b as shown in FIG. 1B may comprise a microfluidic channel 120 having a spiral configuration. That is, the microfluidic channel 120 with the spiral configuration comprises channel portions having all possible orientations (e.g., 0° to 180°) with respect to a direction of the propagation path of the travelling acoustic wave in the interaction region. For example, image (a) in FIG. 1B depicts a particle solution flows from the inlet (just out of frame) to the outlet through a single microfluidic channel. Image (b) in FIG. 1B, by applying an acoustic travelling wave, particles in the fluid sample may be directed to the channel edges. Image (c) in FIG. 1B illustrates a close-up of the outlet showing that all particles at the outlet have been shifted to the channel edges. These particles may then be collected or rejected as per the application requirements. In a non-limiting example, microfluidic channel with spiral configuration may have a width approximately half of the wavelength of the acoustic travelling wave.

FIG. 1C depicts a schematic drawing of microfluidic devices 100c-100e for acoustic particle manipulation according to various embodiments of the present invention, which is similar to the microfluidic device 100a, except that the microfluidic channel 120 of the microfluidic devices 100c-100e each have different example configurations or designs (e.g., third example configuration, fourth example configuration, fifth example configuration, respectively). The transducer 130 (not shown in FIG. 1C) may be arranged, for example, in the air pocket regions on above or below the microfluidic channel 120 in the center. The microfluidic channel 120 of the microfluidic device 100c comprises a semicircle configuration with respect to the direction of the propagation path of the travelling acoustic wave in the interaction region. For example, the microfluidic channel 120 comprises at least three channel portions (e.g., a first channel portion 120a, a second channel portion 120b, a third channel portion 120c) having three orientations, respectively, that are different from each other with respect to a direction of the propagation path of the travelling acoustic wave in the interaction region.

With respect to the microfluidic device 100d and 100e, the at least three channel portions of the microfluidic channel 120 comprise a first channel portion 120a, a second channel portion 120b, a third channel portion 120c. For example, the first channel portion 120a, the second channel portion 120b, and the third channel portion 120c may each be a sub-microchannel structure extending from a channel wall of the microfluidic channel, wherein a surface (or interface) of the sub-microchannel structure is arranged to produce fluid wavefronts based on substrate-propagated acoustic waves such that the fluid wavefronts and subsequent substrate-propagated acoustic waves interfere with one another to generate periodic acoustic force fields in the fluid sample for manipulating the particles.

The microfluidic channel may be relatively narrow or wide. According to various embodiments, acoustic forces may be generated in the microfluidic channel regardless of the orientations of the channel portions. Despite the traveling nature of the substrate wavefronts, according to various embodiments, a time-averaged pressure field is generated in the microfluidic channel which may be used for microparticle manipulation. For example, traveling substrate wavefronts typically do not produce time-averaged pressure field in unbounded microfluidic channels.

For the sake of clarity and conciseness, unless stated otherwise, various embodiments of the present invention will be described hereinafter with reference to the microfluidic device 100 having an example configuration as shown in FIG. 1A (i.e., the first example configuration). It will be appreciated by a person skilled in the art that various features and associated advantages described with reference to the first example configuration may similarly, equivalently or correspondingly apply to the second, third, fourth and fifth example configurations, and thus need not be explicitly stated or repeated for clarity and conciseness.

The acoustic travelling wave that propagates on the substrate surface towards an interaction region associated with the microfluidic channel may be spatially distributed (spatially distributed travelling wave). For example, the acoustic travelling wave generated by the transducer may be regarded as locally confined by the microfluidic channel. The microfluidic channel arranged over the substrate bounds the spatial extent of the transducer. For example, according to the Huygens-Fresnel Principle, the acoustic displacement at a given point in the fluid domain may be the summation of the contributions from everywhere on the substrate that is not bound by the microfluidic channel. Since the microfluidic channel imposes finite edges to the oscillating surface, the result is spatial gradients in the acoustic force potential field.

According to various embodiments, time-averaged periodic acoustic radiation force fields may be advantageously produced using only a single travelling (substrate) wave with a channel wall in its path, and the periodic acoustic radiation force fields are directly coupled to the channel wall orientations. Accordingly, channel walls or channel interfaces of the microfluidic channel may be used to create periodic patterning or focusing with the imposition of a travelling wave. The periodic acoustic force fields are spatially variable acoustic force fields in the microfluidic channel. In various embodiments, all possible angles and orientations of the microfluidic channel may be used for particle manipulation. In other words, arbitrarily angled microfluidic channels may be used for microparticle manipulation. Accordingly, an advantage of the microfluidic device as compared to a conventional microfluidic device using a standing wave SAW (generated with two opposing transducers) is that there is no need for precise and accurate channel/substrate alignment. Further, the distribution of the generated field gradients are not limited, unlike field gradients in conventional techniques which follow sinusoidal distributions. Various embodiments may employ narrow microfluidic channels and wider (high aspect ratio) microfluidic channels that may have features embedded within. Accordingly, microscale patterning may be performed using channel walls of the channel portions and features embedded within microfluidic channels.

Using only travelling waves to generate periodic spacings according to various embodiments of the present invention not only simplifies device setup and design, for example compared to using a waveguide and standing SAW devices, but also couples particle actuation to the channel geometry rather than just the underlying travelling wave, allowing for highly localized patterning and focusing activities that may be incorporated by shaping the channel features. Various embodiments of the present invention may be used for example for cell separation, particle sorting (e.g., according to cell type), industrial processing (e.g., to sort, concentrate and filter nanoparticle and microparticle suspensions) and sample preparation applications (e.g., concentrating cells and microbeads for sample preparation particularly where conventional laboratory processes such as centrifugation are poorly suited for the task). For example, by inserting a mixed cell population in the microfluidic device and using acoustic forces to direct particles to specific channel positions the cells may be efficiently fractionated. This advantage or technical effect will become more apparent to a person skilled in the art as the microfluidic device 100 is described in more detail according to various embodiments or example embodiments of the present invention.

It will be understood by a person skilled in the art that the channel portions of the microfluidic channel are not limited to the configuration (e.g., number, arrangement, position and/or shape) as shown in FIGS. 1A-1C, which are for illustrative purpose only and without limitation. For example, in various embodiments, the at least three channel portions having three orientations, respectively, that are different from each other with respect to a direction of the propagation path of the travelling acoustic wave in the interaction region associated with the microfluidic channel, may have different shapes with respect to each other. For example, the first channel portion may have a circular shape, the second channel portion may have a triangular shape, and the third channel portion may have a rectangular shape. As will be described hereinafter according to various embodiments or example embodiments of the present invention, the microfluidic channel may be configured as appropriate as long as there are at least three channel portions having three orientations, respectively, that are different from each other with respect to a direction of the propagation path of the travelling acoustic wave in the interaction region associated with the microfluidic channel, based on various factors or considerations, without deviating from the scope of the present invention.

In various embodiments, one of the at least three channel portions comprises an orientation having an angle which is non-parallel and non-perpendicular with respect to the direction of the propagation path of the travelling acoustic wave.

In various embodiments, one of the at least three channel portions comprises an orientation having an angle ranging from about 1 degree to about 89 degrees with respect to a direction of propagation of the travelling acoustic wave.

In various embodiments, one or more of the at least three channel portions comprise an orientation with a flat surface.

In various embodiments, one or more of the at least three channel portions comprise an orientation with a curved surface. In various embodiments, a curvature of the curved surface is configured based on a desired periodicity of the acoustic force fields. In various embodiments, the curvature of the curved surface may range from about 50 to about 1000 μm.

In various embodiments, the at least three channel portions may be integrally formed such that the microfluidic channel is continuous.

In various embodiments, the at least three channel portions comprise a first channel portion, the first channel portion is a channel wall (e.g., sidewall of the channel on the substrate surface) of the microfluidic channel.

In various embodiments, the at least three channel portions comprise a second channel portion, the second channel portion is a sub-microchannel structure extending from a channel wall of the microfluidic channel, wherein a surface of the sub-microchannel structure is arranged to produce fluid wavefronts based on substrate-propagated waves such that the fluid wavefronts and subsequent substrate-propagated acoustic waves interfere with one another to generate periodic acoustic force fields in the fluid sample for manipulating the particles. The sub-microchannel structure may be arranged along the fluid pathway in the microfluidic channel.

In various embodiments, the sub-microchannel structure is a micropillar.

In various embodiments, the particle manipulation comprises particle patterning.

In various embodiments, the substrate comprises a piezoelectric substrate. For example, the substrate comprises a piezoelectric material that converts an electrical input into travelling wavefronts with displacements on the substrate surface.

In various embodiments, the transducer may comprise an electrode pattern or design over the piezoelectric substrate which is used to couple the electrical input to the substrate to produce mechanical substrate displacements which produces the acoustic travelling wave. For example, the transducer may be an electro-acoustic transducer. In various embodiments, the transducer is an interdigital transducer (IDT) having parallel interdigitated electrodes. The produced acoustic wave may propagate in a direction perpendicular to the parallel interdigitated electrodes. In some cases, the electrode and piezoelectric material or layer on the substrate which converts the electrical input to produce the acoustic travelling wave with displacements on the substrate surface may be collectively referred to as the transducer herein.

The acoustic travelling wave comprises travelling acoustic wavefronts which may be a number of acoustic type of wavemodes, including but not limited to, Lamb waves, Love waves, Rayleigh waves and Sezawa waves. A characteristic of these type of wavemodes is that these waves have some surface displacement that may couple acoustic energy into an adjoining fluid. Such acoustic type of wavemodes may be collectively referred to as a surface acoustic wave (SAW). Accordingly, in various embodiments, the acoustic travelling wave comprises a surface acoustic wave (SAW). The travelling acoustic wavefronts for microfluidic applications according to various embodiments may range from about 1 μm to about 1000 μm.

In various embodiments, the transducer is arranged on the substrate surface at predetermined distance from the microfluidic channel. In a non-limiting example, the predetermined distance may range from about 0 to about 20 mm.

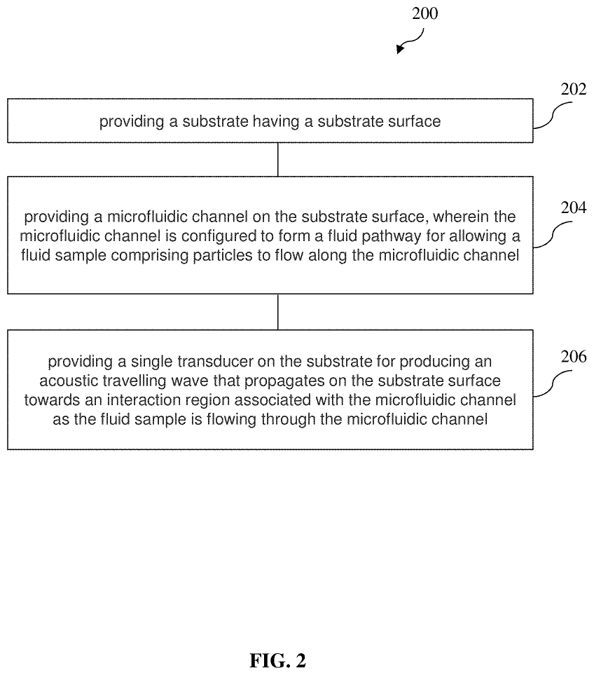

FIG. 2 depicts a schematic flow diagram of a method 200 of forming a microfluidic device, such as the microfluidic device 100 as described herein with reference to FIGS. 1A-1C. The method 200 comprises: providing (at 202) a substrate having a substrate surface; providing (at 204) a microfluidic channel on the substrate surface, wherein the microfluidic channel is configured to form a fluid pathway for allowing a fluid sample comprising particles to flow along the microfluidic channel; and providing (at 206) a single transducer on the substrate for producing an acoustic travelling wave that propagates on the substrate surface towards an interaction region associated with the microfluidic channel as the fluid sample is flowing through the microfluidic channel. In particular, the microfluidic channel comprises at least three channel portions having three orientations, respectively, that are different from each other with respect to a direction of the propagation path of the travelling acoustic wave in the interaction region, wherein the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

In various embodiments, the method 200 is for forming the microfluidic device 100 as described hereinbefore with reference to FIG. 1, therefore, the method 200 may further include various steps corresponding to providing or forming various configurations and/or components/elements of the microfluidic device 100 as described herein according to various embodiments, and thus such corresponding steps need not be repeated with respect to the method 200 for clarity and conciseness. In other words, various embodiments described herein in context of the microfluidic device 100 is analogously or correspondingly valid for the method 200 (e.g., for forming the microfluidic device 100 having various configurations and/or components/elements as described herein according to various embodiments), and vice versa.

It will be appreciated by a person skilled in the art that various steps of the method 200 presented in FIG. 2 may be performed concurrently or simultaneously, rather than sequentially, as appropriate or as desired.

By way of examples only and without limitation, the substrate 110 may be formed of glass (e.g., borosilicate glass), quartz or a polymer wafer. For example, the microfluidic device 100 may be formed or fabricated based on a standard soft-lithography method. The microfluidic channel 120 comprising at least three channel portions having three orientations, respectively, that are different from each other with respect to a direction of the propagation path of the travelling acoustic wave in the interaction region, may be first designed in a 2D drawing software (e.g., AutoCAD), which may correspond to a top-view of the channel 120, for example as illustrated in FIGS. 1B and 1C. A mask may then be printed exactly according to the above-mentioned 2D design with the channel portions as transparent on a dark background. A master mold may be prefabricated using photolithography with a negative photoresist according to the mask printed in the previous step, which generates the same channel design (or channel configuration) as the channel design on the mask. In addition, the channel height may be controlled based on the corresponding thickness of photoresist. For example, polydimethylsiloxane (PDMS) material may be made by mixing base and cross-linking agent in a ratio of 10:1 and then poured onto the master mold. The PDMS mixture may then baked at 100° C. for 1 hour to achieve a complete cross-linking. The cured PDMS has the same configuration as the channel configuration of the master mold, including the channel height. The cured PDMS may then be peeled off from the master mold and punched holes to form the inlet(s) and outlet(s) for tubing connection. The PDMS replica may then be subsequently bonded onto microscopic glass slides after processing by air plasma cleaner to manufacture the microfluidic device 100. For example, the microfluidic channel may be formed of a material (e.g., PDMS) that has an acoustic impedance mismatch with the fluid sample (e.g., water).

As for the transducer, it may comprise an electrode pattern which correspond to desired wavelength of the acoustic travelling wave to be produced on the substrate. In a non-limiting example, the transducer may be bonded to the substrate. For example, SAW-producing transducers may be bonded to 2D microfluidic devices and may efficiently couple acoustic energy into an overlaying fluid domain in the microfluidic channel.

FIG. 3 depicts a schematic flow diagram of a method 300 of manipulating particles (e.g., different types of particles, such as cells) in a fluid sample based on a traveling acoustic wave using the microfluidic device 100 as described hereinbefore according to various embodiments. The method 300 comprises: flowing (at 302) the fluid sample comprising particles through the microfluidic channel of the microfluidic device to manipulate the fluid sample, including the particles therein; generating (at 304) an acoustic travelling wave using the single transducer that propagates on the substrate surface towards an interaction region of the microfluidic channel as the fluid sample flows through the microfluidic channel such that the at least three channel portions produces fluid wavefronts based on substrate-propagated acoustic waves such that the fluid wavefronts and subsequent substrate-propagated acoustic wavefronts interfere with one another to generate periodic acoustic force fields in the fluid sample; and patterning (at 306) the particles based on the periodic acoustic force fields in the interaction region of the microfluidic channel.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various example embodiments provide a microfluidic device for generating acoustic force fields and manipulating microparticles (e.g., cells) in microfluidic channels using acoustic travelling wave whose spatial extent is limited by channel walls (e.g., corresponding to the microfluidic device 100 described hereinbefore according to various embodiments). Acoustic forces are a dynamic method for manipulating microscale particles. Various example embodiments detail a method for generating an acoustic field from a substrate wave that may drive particles towards minimum energy locations in a microchannel without the use of a standing wave to drive the system. The microfluidic device according to various example embodiments employs a travelling substrate wave to create a non-uniform acoustic displacement distribution in an overlaying fluid that is bounded in a microfluidic channel (corresponding to the microfluidic channel 120). When the channel width is sufficiently small, dense particles will all migrate toward the channel sides and less dense particles will migrate towards a single point in the middle of the microfluidic channel. According to various example embodiments, the particle motion driven by the generated acoustic field may be regardless of the channel orientation with respect to the incoming substrate wave orientation. For purpose of illustration, various example embodiments will be described with respect to a surface acoustic wave (SAW), however, it will be appreciated by a person skilled in the art that other types of acoustic travelling wave may be employed.

In an acoustic standing wave, dense particles migrate towards nodal positions in the acoustic field. Conventional techniques of acoustic forces have relied on generating a standing wave in a resonating channel or a standing wave on a substrate that creates a periodic force distribution on an overlaying fluid. In both cases a highly particular frequency, channel width and/or channel alignment is required to create robust particle migration towards the desired locations. On the other hand, various example embodiments of the present invention are advantageous in that the acoustic field distribution is automatically aligned with the channel, since it is the limited spatial domain of the transducer which is imposed by the microfluidic channel that causes spatial gradients in the acoustic radiation forces. In other words, the spatial domain of the transducer is limited or defined by areas bounded by the microfluidic channel according to various embodiments, and such spatial domain produces the spatial gradients in the acoustic radiation forces

The physics of acoustic-based microfluidic systems have been extensively explored, where the effects of acoustic streaming and acoustic radiation forces arising from standing waves and travelling waves have been well accounted for. These models, however, are largely predicated on the existence of spatially periodic acoustic fields along the propagation direction without accounting for the effect of channel elements in the SAW path. With the exception of the so-called anechoic corner, where total internal reflection (TIR) at the channel-fluid interface results in an acoustic void near the channel interface, the effects of channel interfaces on the acoustic field remain largely unexplored. The TIR at the channel edge has an effect across the entire fluid domain, where diffractive interference patterns arise from the imposition of a channel-bounded travelling SAW. TIR occurs when a wavefront propagates between domains with different sound speeds. In the case of a combination of materials for the microfluidic channel and the fluid sample such as PDMS for the microfluidic channel and water the fluid sample, where the PDMS sound speed (c_{PDMS} of about 1030 m/s) is lower than that of water (cₗ of about 1500 m/s), wavefronts intersecting this boundary from any point above a critical angle

$${θ}_{c} = {sin}^{- 1} \frac{{c}_{P D M S}}{{c}_{l}}$$

(e.g., θ_{c} of about 43 degree) (measured from the transducer plane) are entirely reflected and do not contribute to the acoustic field in the fluid. Since the acoustic wavefronts typically propagate from the substrate into PDMS at a Rayleigh angle, θ_{R} which is less than θ_{c}, approximately 22° for water on lithium niobate, it has been shown that a channel wall of the microfluidic channel (e.g., formed of PDMS) may act as an effective boundary that limits the extent of the SAW transducer domain in a microchannel.

It one study, it has been demonstrated that a meshless quasi-analytical model based on the assumption that the pressure magnitude at a given point in the fluid is equal to the sum contribution from spherically expanding wavelets emanating from a finite transducer area. The study showed that particle patterns can be generated without the imposition of a standing SAW, where time-averaged acoustic periodic fringe spacing arises from diffractive effects associated with a spatially limited transducer domain. This contrasts somewhat with another study that demonstrated PDMS walls had negligible acoustic effects, permitting particle patterning in fluid domains that are a subset of the resonant wall dimensions. This particular case differs from the above-mentioned demonstration of channel-induced patterning in SAW devices, however, since in standing-wave resonant acoustic fields the intersecting wavefronts travel perpendicular to the water/PDMS interface, at an angle greater than θ_{c}, and are thus not subject to TIR. It is possible to generate strong fringe patterns with traveling SAW, however, because the wave propagation direction through the fluid is less than the critical angle (θ_{R}<θ_{c}), causing TIR. For other common potential polymer channel materials including polymethyl methacrylate (PMMA), polycarbonate and polystyrene, all with sound speeds greater than water, the condition θ_{R}<θ_{c} is not met, and acoustic energy can couple into the fluid at all points along the channel height. While fringe patterns would still result (since a portion of the acoustic energy traveling toward the polymer/fluid interface is still reflected back into the polymer), the transducer extent would not be as effectively limited as would be the case where all the acoustic energy is reflected (θ_{R}<θ_{c}).

According to various example embodiments, directly using channel wall TIR effects facilitates creating particle patterns that are inherently aligned with channel features while avoiding the additional alignment and bonding steps, for example, that using a waveguide layer entails. Since channel walls are essentially ubiquitous in microfluidic SAW, it is important to account for the effects that their presence will have on the acoustic field and resultant particle patterning.

According to various embodiments, generalized acoustic interaction models to predict acoustic field periodic fringe spacing are provided for channel interfaces subject to a travelling substrate wave. This facilitates understanding of channel interface effects on the surrounding acoustic field.

According to various embodiments, geometrically deduced analytical models are provided based on the interaction between both straight and curved channel interfaces with a SAW. These models predict the acoustic force-field periodicity near (or around) a channel interface as a function of its orientation to an underlying SAW, and are validated with experimental and simulation results. It is noted that the spacing is larger for flat walls (or interfaces) than for curved walls and is dependent on the ratio of sound speeds in the substrate and fluid. Generating these force-field gradients with only travelling waves has a wide range of applications in acousto-fluidic systems, where channel interfaces may support a range of patterning, concentration, focusing and separation activities by creating locally defined acoustic forces.

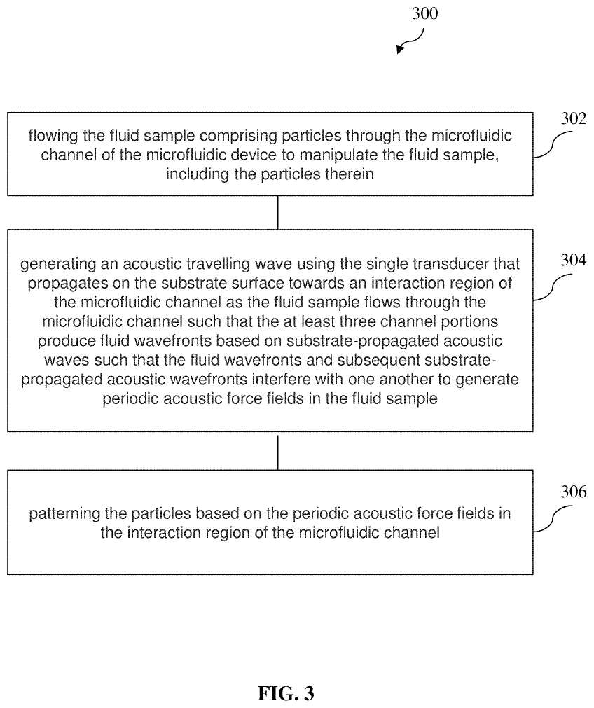

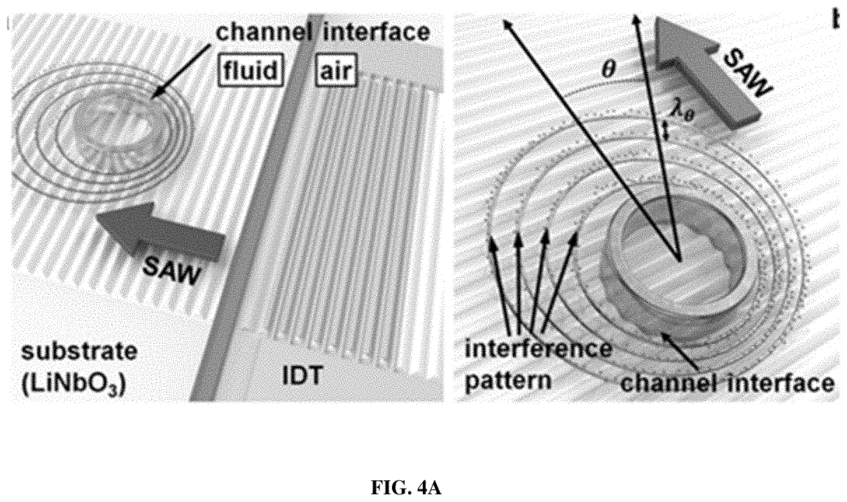

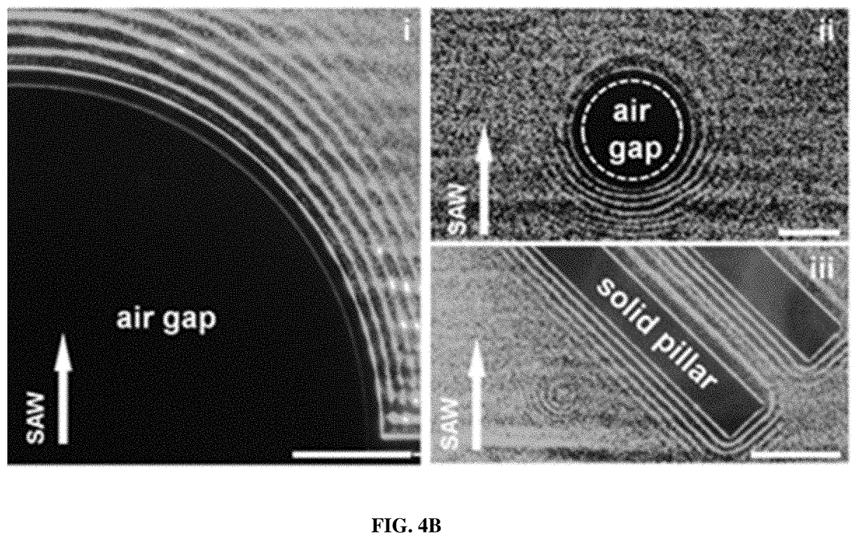

FIGS. 4A-4B illustrate channel features, including curved ones, in the propagation path of a SAW may be used to create particle patterns. The scale bars for images in FIG. 4B are 200 μm. FIG. 4A illustrates a conceptual image showing interference patterns, where the interaction of SAW wavefronts from a substrate-bound wave (corresponding to the subsequent substrate-propagated acoustic wavefronts) and fluid wavefronts from a channel interface in its path (corresponding to fluid wavefronts produced based on substrate-propagated acoustic waves) results in force potential minima locations in the fluid. For example, an incident surface acoustic wave (SAW) arising from an interdigitated transducer interacts with a channel interface to produce an interference pattern with periodicity λ_{θ}. As shown, interference in the vicinity of a channel interface produces patterning phenomena. FIG. 4B shows images illustrating the effect of channel walls in representative experimental cases, including curved i) and ii) and straight (iii) channel interfaces. More particularly, the experimental results shows 1 μm diameter particle patterning within a microfluidic channel. For example, the experimental cases relate to 1 μm microparticle patterning from a (i) semicircle, (ii) circle (iii) and rectangular channel interfaces. The PDMS-air interfaces are denoted by a dashed white line. PDMS-air interfaces are denoted by a dashed white line. Though the air gaps shown may be useful in limiting SAW attenuation, where the substrate-air interface is much less attenuating than the substrate-PDMS one, this is not necessary to produce patterning effects around channel interfaces due to TIR at the PDMS/water interface. Various example embodiments show that channel walls may be used to generate locally defined acoustic fields from travelling SAW with arbitrary wall orientations, which is useful for flexible acoustic micro-patterning. Various example embodiments further provide analytical models that predict the acoustic field periodicity used to drive micromanipulation in these systems. Various example embodiments show that channel curvature may impact periodicity and accordingly analytical models to predict diffractive periodicity in SAW-based microfluidic devices are derived and tested.

### Principle

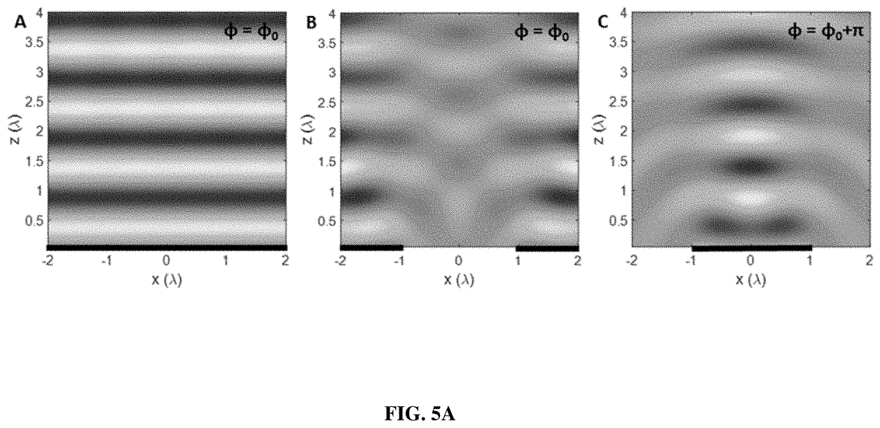

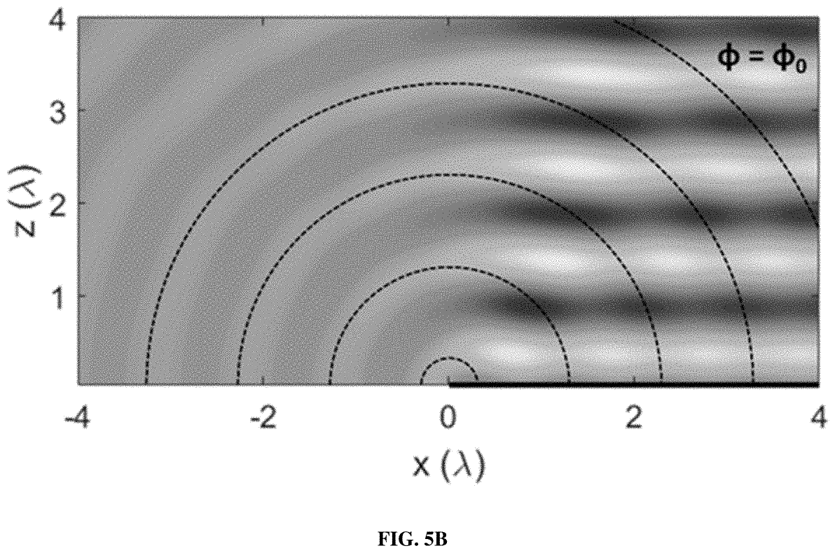

The well-understood physical concepts of the Huygens-Fresnel principle and the linear superposition of wavefronts is applied in order to develop novel predictive models that describe particle patterning in microfluidic devices actuated by SAW. A consequence of the Huygens-Fresnel principle, which states that a wavefront is the sum of all wavelet contributions from the extent of a wave source, is that a finite transducer area appears to generate spherical wavelets that emanate from the transducer edges. These wavelets have been visualized experimentally as edge waves with short-duration pulses. In the case of oscillatory acoustic waves, these wavelets are more appropriately thought of as a ‘virtual field’ that represents negative wavefront contributions from all regions outside of the transducer domain that then interfere with the planar wavefronts from the transducer. This principle is briefly illustrated with respect to FIGS. 5A-5B, where the field emitted from a finite transducer width is equivalent to the sum of planar wavefronts with the 180° out-of-phase wavelets emanating from everywhere outside of transducer domain or region. In the case of a SAW coupling into an overlaying fluid, the transducer boundaries are defined by the channel walls, resulting in 180° out-of-phase wavelets from the edges of the channel wall that coalesce into fluid wavefronts. These interfere with the classical planar wavefronts emanating from the substrate. These latter wavefronts are herein referred to as “SAW wavefronts” (corresponding to the subsequent substrate-propagated acoustic wavefronts as described hereinbefore) to highlight that their wavelength and sound speed (as measured in the x-y plane) is equivalent to that of the underlying substrate wave.

Various example embodiments establish a comprehensive theory of channel wall interactions and examine the full range of channel wall orientations θ (θ is the orientation of the channel wall relative to the direction of the propagation path of the travelling acoustic wave (e.g., SAW propagation direction)). In doing so, models to predict the fringe (or pattern) spacing, λ_{ν}, as a function of θ with respect to the SAW propagation direction (along the +x direction) and the interface curvature are developed. These two-dimensional (2D) models are formulated in the transducer plane (the x-y plane), which is appropriate given the high aspect ratio of the channels used (e.g., wide and relatively shallow) to observe these fringes and this being the plane on which microfluidic devices are usually observed, namely in a top-down or inverted microscope. While these models are appropriate for the cases considered, with channel heights on the order of the acoustic wavelength or smaller, the acoustic field also evolves in the z-direction with minor changes in the fringe spacing for increasing z and close to a channel boundary.

FIG. 5A illustrate properties of finite transducers with three cases (A, B and C). All three cases are modelled separately according to the Huygens-Fresnel principle, where the pressure magnitude in the fluid at a given point is equal to the sum of the contributions from all points along the transducer extent. Case A shows a series of planar wavefronts arising from a transducer whose extent is much larger than the shown region (e.g., width W of about 100 λ). The transducer extent in case B is identical, with the exception of a non-emitting region between −λ<x<λ. Case C may be deduced in one of two ways: either as an independent wavefield with a 180° phase difference (with φc=φ_{A,B}+π) from case A and B, or by subtracting case B from case A (C=A−B). Equivalently, the wave field in case B can be derived by adding the wavefield from case C to A (B=A+C). Accordingly, the effect of a finite transducer extent may be modelled by adding an oppositely-phased wavefront in the non-transducer domain.

FIG. 5B illustrate the effect of edge waves, or rather that of a spatially limited transducer extent, on the wavefronts emanating from a transducer (black line from x=0 to x=4 λ) can be seen in this plot of the transient pressure field. The expanding cylindrical waves (dotted black lines) from the transducer edge interfere with the planar wavefronts that ultimately results in regions of high-and low time-averaged pressure.

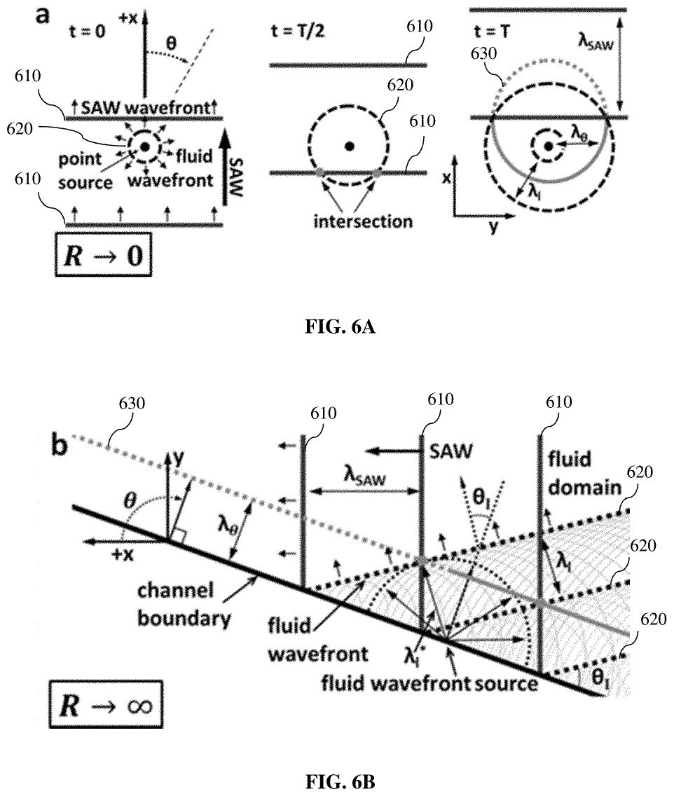

In the case of a channel wall with curvature radii much smaller than the SAW wavelength (with R→0, where R is the radius of curvature), the value of λ_{θ}^{(R→0)} may be predicted by determining the distance from the channel interface that an incoming SAW wavefront (travelling at cₛ) will interfere with a fluid wavefront (travelling at cₗ). It is intuitive that λ_{θ} will vary for different θ, with smaller values when the waves are travelling in opposite directions than when they are co-travelling. This concept is illustrated in FIG. 6A, which shows how the intersection between a SAW wavefront 610 and a fluid wavefront 620 results in an ellipsoidal interference pattern 630. More particularly, FIG. 6A illustrates an interference model in the case where the radius R of the interface is much smaller than the acoustic wavelength (R→0) the scattered fluid wavefront (dashed line 620) intersects with the SAW wavefront arising from the SAW (solid line 610) to produce an ellipsoidal interference pattern (line 630). For example, the modelled intersection of an expanding fluid wavefront and a series of SAW wavefronts for circular channel features with R=0.1 λ_{SAW}, 0.5 λ_{SAW}, 1 λ_{SAW} and 2 λ_{SAW} was performed. The value of λ_{θ}^{(R→0)} for a given θ value may be determined by calculating the time taken for these two waves to intersect, which is longer when these wavefronts are traveling in the same direction (θ equal to 0°), and shorter when they are travelling in opposite directions (θ equal to 180°). At their intersection these wavefronts will destructively interfere, since the fluid wavelets are 180° out of phase with the SAW wavefront. Because a travelling SAW is periodic, these intersections will occur at consistent locations, resulting in a periodic series of nodal and anti-nodal positions radiating outward from the channel feature. The periodicity of this interference pattern can be defined in terms of the acoustic wavelength in the fluid (or liquid),

$${λ}_{l} = \frac{{c}_{l}}{{c}_{s}} {λ}_{S A W} ,$$

and the fluid (or liquid) and substrate sound speeds, cₗ and cₛ, respectively, as follows:

$${λ}_{θ}^{( R \to 0 )} = \frac{{λ}_{l}}{( 1 - \frac{{c}_{l}}{{c}_{s}} cos θ )} \qquad Equation ( 1 )$$

The derivation for Equation 1 will be described later.

For simplicity, only one SAW wavefront-channel interaction is shown in FIG. 6A. This spacing is conserved for subsequent interactions between any given fluid wavelets (fluid wavefronts) and further SAW wavefronts. It is relatively simple to calculate this spacing because the wavelet source is co-located with the object centre regardless of θ (when R→0). While this condition (in the Rayleigh scattering regime) is an interesting case, channel walls and interfaces are, however, most often either flat or have a finite and observable shape. This simultaneous co-location of wavelet source and SAW wavefront cannot be assumed for flat walls, as the origin of the expanding wavelet that coheres at the intersection point differs from the point where the wavefront and the interface intersect. This is shown conceptually in FIG. 6B for the case where R→∞ (a flat interface). More particularly, FIG. 6B illustrates that in the case of a flat channel interface (R→∞) the fluid wavefronts 620 similarly intersect with the planar

SAW wavefronts 610 in the fluid to produce an interference pattern 630 parallel to the interface.

The periodicity of an interference pattern in the vicinity of a channel interface may be solved through straightforward trigonometry, as follows:

λ_{θ}^{(R→∞)}=λₗ sin(θ)csc(θ−θ_{I}(θ)) Equation (2)

where csc(θ) is the cosecant of θ and θ_{I}(θ) is the intersection angle, given by

$${θ}_{I} ( θ ) = {sin}^{- 1} ( \frac{{c}_{l}}{{c}_{s}^{*} ( θ )} ) \qquad Equation ( 3 )$$

which describes the angle at which a coherent fluid wavefront projects from the channel wall. This is analogous to the definition of the Rayleigh angle, θ_{R}(θ)=sin⁻¹(cₗ/cₛ), which describes the angle at which fluid wavefronts project from travelling substrate waves into an adjoining fluid domain. When the sound speed in the fluid domain is less than that of the SAW phase velocity, the wavefronts propagate at an angle from the substrate into the fluid. The key difference here is that the substrate wave velocity cₛ*(θ) is instead the speed of a travelling substrate wave intersecting with a channel wall angled at θ. More particularly, this value will change with θ, and is expressed as follows:

$${c}_{s}^{*} ( θ ) = \frac{{c}_{s}}{sin ( θ )} \qquad Equation ( 4 )$$

This means that while cₛ*(θ) is equal to the sound speed in the substrate at θ equal to 90°, as θ approaches 0° or 180° cₛ*(θ) approaches infinity in an analogous manner to the “lighthouse” or “scissors” paradox. In the scissors paradox, for example, from the perspective of the person holding the scissors the contact point between the sufficiently long scissor halves can achieve superluminal velocities as the angle between them approaches zero. The intersection point between the SAW wavefront and the channel wall can similarly achieve arbitrarily high velocities for small angles between the two. For reference, the scissors paradox is resolved since special relativity is not actually violated, as information still cannot travel faster than the speed of light.

Substituting these expressions into Equation 2, an expression that predicts the fringe spacing as R→∞ may be obtained, as follows:

$${λ}_{θ}^{( R \to ∞ )} = {λ}_{l} sin ( θ ) csc ( θ - {sin}^{- 1} ( \frac{{c}_{l}}{{c}_{s}} s i n θ ) ) \qquad Equation ( 5 )$$

The full derivation for Equation 5 will be described in detail later.

These expressions (Equation 1 and 2) describe models at either extreme (with R→0 and R→∞) and demonstrate that the interface curvature influences the fringe spacing. Both expressions for λ_{θ} described here denote the distance between subsequent SAW wavefront and fluid wavefront intersections, where this spacing is equivalent to the distance between acoustic force potential minima.

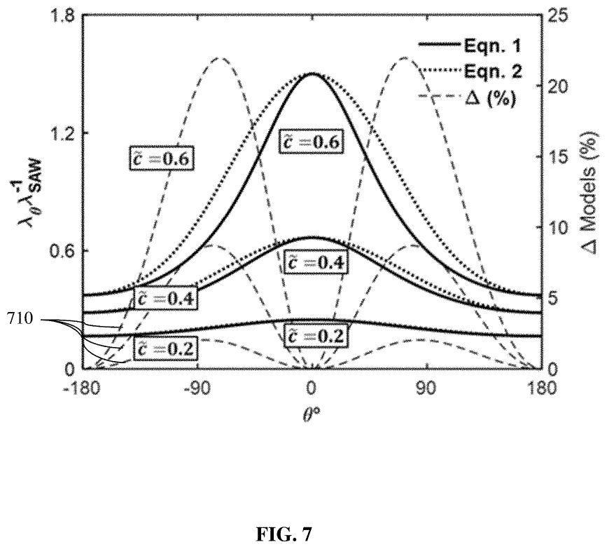

FIG. 7 examines the behaviour of these models for different sound speed ratios, \tilde{c}=cₗcₛ⁻¹. More particularly, FIG. 7 illustrates periodic spacing near a channel interface for models in the case where R→0 (Equation 1) and R→∞ (Equation 2) plotted for values of \tilde{c} of 0.2, 0.4 and 0.6. Dashed lines 710 denote the percentage difference between these models with θ, whose magnitude increases as e approaches unity. While the models in Equation 1 and 2 are equivalent for the separate cases of θ equal to 0° and θ equal to 180° (λ_{0°}^{(R→0)}=λ_{0°}^{(R→∞)} and λ_{180°}^{(R→0)}=λ_{180°}^{(R→∞)}), discrepancies occur at intermediate values of θ and increase for higher values of \tilde{c}. For a value of \tilde{c}=0.39, representative of a LiNbO₃ substrate and a particle-laden H₂O liquid (with cₗ=1540 m/s and cₛ=3931 m/s), the maximum difference between these models is equivalent to approximately 0.08 λ_{θ}^{(R→∞)} at θ=±78°. While the difference between these models is small for most intermediate angles, this discrepancy is nevertheless manifested and measurable.

The expressions in Equations 1 to 5 are predicated on the intersection of linear (first order) pressure fields in the fluid. Because these pressure fields are oscillatory in nature, the time average of these first order fields is necessarily zero. As will be described in later, however, these linear pressures give rise to a (time-averaged) non-linear acoustic force field that can be used to pattern microparticles, where the spacings between individual acoustic force potential minima along which particles aggregate are equal to λ_{θ}. In the following theory, experiments and simulations, it is shown how a spatially limited transducer gives rise to a non-uniform acoustic radiation force distribution and demonstrate the power of these models for predicting interference patterns near (or around) channel features subject to a travelling SAW.

### Acoustic Model

To map the acoustic forces in the fluid, the distribution of the oscillatory velocities in the fluid domain needs to be considered. In the case of a spatially limited transducer domain, the value of the fluid oscillation velocities may be determined through the sum of contributions from the substrate and the wavelets from the channel wall. The first of these, the wavefronts propagating from the substrate surface into the fluid domain (the SAW wavefronts), are well characterised and have (first order) fluid particle velocities of vₛ propagating in the fluid at an angle θ_{R}=sin⁻¹(cₗ/cₛ), with θ_{R} measured with respect to the vertical axis. The first order fluid velocities are given as follows:

vₛ=A(x, z)ωξ₀e^{iωt}e^{-i(k}^{ₛ}^{x}^{_{θ}}^{cos θ)}e^{-k}^{ₗ}^{z} Equation (6a)

A=e^{-α(x}^{_{θ}}^{-ztanθ}^{_{R}}^{)-μz sec θ}^{_{R}}^{)cos θ} Equation (6b)

where kₛ, kₗ are the wavenumbers in the substrate and liquid, θ is the angle of the channel wall, ω is the angular frequency, ξ₀ is the displacement magnitude, x_{θ} is the direction perpendicular to the channel wall, and the cos θ term above accounts for the different SAW propagation directions along x_{θ}. In the case of θ equal to 0°, for example, x_{θ} (and the SAW propagation direction) is in the +x direction, whereas it is the −x direction when θ=π. The parameter A can take on values between 0 and 1 and accounts for attenuation at the substrate/fluid interface and in the fluid itself via the terms α and β, respectively. Equation 7b has been modified from this reference to account for different values of θ. These attenuation parameter values are given by

$$\begin{matrix}α = \frac{{ρ}_{{l}^{C} l}}{{ρ}_{s} {c}_{s} {λ}_{S A W}} & Equation ( 7 a ) \\ β = \frac{b {ω}^{2}}{{ρ}_{l} {c}_{l}^{3}} & Equation ( 7 b )\end{matrix}$$

where

$$b = \frac{4}{3} μ + {μ}^{′} ,$$

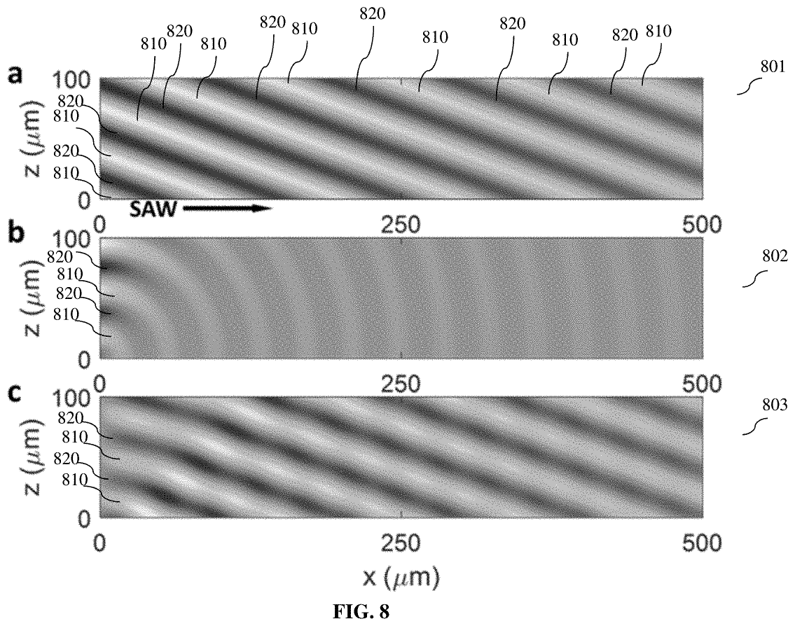

with μ and μ′ being the fluid viscosity and bulk viscosity, respectively. These are temperature-dependent values, with μ=8.9×10⁻⁴ Pa·s and μ′=2.5×10⁻³ Pa·s at 25 C.° and μ=6.5×10⁻⁴ Pa·s and μ′=1.8×10⁻³ Pa·s at 40 C°. Regardless, for the devices used here the attenuation along the substrate has a greater effect than that in the fluid; whereas the attenuation length α⁻¹ is about 12 λ_{SAW} for water on lithium niobate, the value of β⁻¹ (the attenuation length in the fluid) is at least an order of magnitude larger for frequencies less than 100 MHz. This is seen in FIG. 8, where the attenuation in the z-direction is almost unnoticeable whereas the wavefront magnitude is appreciably smaller at the right edge of the domain. More particularly, FIG. 8 shows images 801-803 illustrating first order transient acoustic pressures in the x-z plane arising from the velocities with respect to (a) Equation 11 and (b) Equation 13 which will be desribed later, where (c) shows the sum of these pressures, with pₛ+p_{c}. This results in visible diffraction lobes in the combined field in the fluid domain. These plots are for λ_{SAW} of 100 μm, θ of 0° and a channel wall at x=0, where in these arbitrarily scaled images the region 810 represents the maximum pressure condition and the region 820 is the minimum pressure. Each SAW wavefront creates a new fluid wavelet in image 802 as it enters the channel.

The second contribution arises from channel features which limit the spatial extent of the transducer, and act as a virtual source of wavelets. These wavelets represent the wave components that would otherwise have propagated from regions outside of the transducer but are instead blocked by TIR at the channel features, hence they are assigned an opposite phase to the planar wavefronts in Equation 6, noting again that the final acoustic field magnitude can be computed from the sum of planar wavefronts with phase 0° and the 180° out-of-phase fluid wavelets as described above with respect to FIG. 5A. These wavelets combine to form an acoustic beam projecting from the substrate at θ_{R} representing contributions from outside the channel domain. A complete solution for this acoustic field would require a numerical simulation to determine the specific beam profile. For high aspect ratio channels (width greater than height) and/or small θ_{R}, however, it is only the expanding wavelet components travelling mostly parallel to the substrate that gives rise to the interference fringes in the channel domain. This permits the development of a straightforward 2D analytical solution in the x-z plane by approximating the sum of these virtual wavelets as spherically propagating wavefronts emanating from the channel edge adjoining the transducer.

It is examined here the case of a flat channel wall, in which the spherically propagating wavelets combine into cylindrical wavefronts that have equal magnitude along the length of the channel wall. These first order cylindrical wavefront velocities are given by

v_{c}=D(θₕ,r)ωξ₀e^{iωt}e^{-i(k*}^{ᵢ}^{r-π)}e^{-βr} Equation (8)

where θₕ and r define a position in polar coordinates, whose coordinate transformation into the coordinate system of Equation 6 (the x-y plane) is calculated using θₕ=tan⁻¹ z/x_{θ} and r=\sqrt{x_{θ}²+z²}, where x_{θ} is the axis perpendicular to the channel wall in the plane of the transducer. The pressure arising from these velocities are plotted in image 802 in FIG. 8. The value of the fluid wavenumber, k*ₗ=2π/λ*ₗ, accounts for the marginally longer path length between the source of the wavelets on a flat wall and the intersection point with a SAW wavefront, where λ*ₗ can be found geometrically (e.g., see FIG. 6B), with λ*ₗ=λₗ/cos(θ_{I}(θ))=λₗ[cos(sin⁻¹(cₗ/cₛ sin(θ)))]⁻¹.

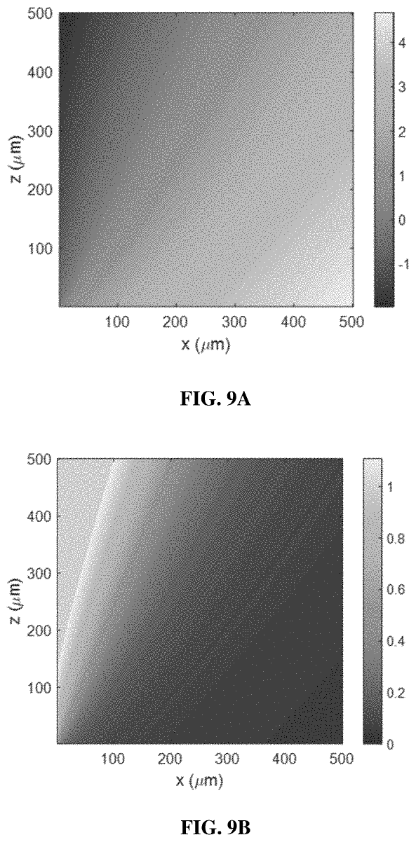

The diffraction coefficient D(θₕ, r) describes the amplitude variation of the contributions from outside the channel. Setting the edge of the channel feature at x_{θ}=0, these will have a finite amplitude distribution across the channel domain between 0 and 1. While the amplitude of D(θₕ, r) may be determined through numerical simulation, the Lee coefficients in Equation 9a as follows provide a good approximation, with

$$\begin{matrix}D ( {θ}_{h} , r ) = \{ \begin{matrix}1 , & υ < - 1 \\ 0.5 - 0.62 υ , & - 1 \geq υ \geq 0 \\ 0 . 5 {e}^{- 0 .95 υ} , & 0 \geq υ > 1 \\ 0.4 - \sqrt{0.118 \; 4 - {( 0.38 - 0.1 υ )}^{2}} , & 1 \geq υ > 2.4 \\ \frac{0.225}{υ} , & υ > 2.4\end{matrix} , & Equation ( 9 a ) \\ υ = r cos ( {θ}_{h} + {θ}_{R} cos θ ) \sqrt{\frac{2}{r {λ}_{l}}} , & Equation ( 9 b )\end{matrix}$$

where υ (upsilon) is the Fresnel-Kirchoff parameter, which is a measure of the distance from the channel boundary. This factor υ and the value of D(θₕ, r) are mapped in FIGS. 9A-9B. The factor cos θ accounts for the orientation of the acoustic beam emanating from outside the channel region. These wavefront contributions from outside the channel represented by Equation 8 are subtracted from the wavefronts in Equation 6. For θ equal to 0°, the acoustic beam is oriented along θ_{R} (into the channel), whereas for θ equal to 180° the acoustic beam contribution is pointed away from the channel (−θ_{R} along the axis x_{θ}). While this factor is included for completeness, the contribution from the [θ_{R} cos θ] term is negligible for distances far from the channel wall and close to the substrate. More particularly, FIGS. 9A-9B illustrate plots of the Fresnel-Kirchoff parameter υ and diffraction coefficient D(θₕ, r), respectively. At the rightmost extent of the plot in FIG. 9B near z=0 (at x=500 μm with a 100 μm SAW wavelength), the value of D(θₕ, r) is equal to about 5%. The beam projects up from the lower right at θ_{R}.

The first order pressure components for the SAW wavefronts and cylindrical fluid wavefronts are found with pₛ=ρ₀cₗvₛ and p_{c}=ρ₀cₗv_{c}, respectively. Adding these yields the total first order pressure, with p₁=pₛ+p_{c}, as illustrated in image 803 in FIG. 8. While the scalar pressure fields can be directly summed, doing so for the velocity field must consider the orientation of the vector fields, summing the contributions in the x and z directions independently. The interference velocity magnitude is given by ∥v₁|={square root over ((vₛ₍ₓ₎+v_{c(x)})²+(v_{s(z)}+v_{c(z)})²)}, where vₛ₍ₓ₎=vₛ sin(θ_{R}), v_{s(z)}=vₛ cos(θ_{R}), v_{c(x)}=v_{c} cos(θₕ) and v_{c(x)}=v_{c} sin(θₕ).

The acoustic radiation force on a particle may be determined from the gradient in the acoustic force potential U as follows.

$$\begin{matrix}{F}^{r a d} = - ∇ U & Equation ( 10 a ) \\ U = {V}_{p} [ {f}_{1} \frac{1}{2} {κ}_{0} 〈 {p}_{1}^{2} 〉 - {f}_{2} \frac{3}{4} {ρ}_{0} 〈 {v}_{1}^{2} 〉 ] , & Equation ( 10 b ) \\ {f}_{1} = 1 - \frac{{κ}_{p}}{{κ}_{0}} , {f}_{2} = 2 ( {ρ}_{p} - {ρ}_{0} ) / ( 2 {ρ}_{p} + {ρ}_{0} ) , & Equation ( 10 c )\end{matrix}$$

where

$${V}_{p} = \frac{4 π}{3} {a}^{3}$$

is the particle volume, κₚ and ρₚ are the particle compressibility and density, and ƒ₁ and ƒ₂ are the monopole and dipole scattering coefficients. It is worth discussing the use of the Gor'kov equation as it has been shown elsewhere that it is only the imaginary components of the scattering coefficients that contribute to the acoustic radiation force in a plane travelling wave, yielding acoustic radiation forces along the propagation direction. However, unlike a plane traveling wave, in the case of various example embodiments of the present invention, there are gradients in the acoustic field, and it is these which lead to particle motion.

It is noted that the force from a traveling wave force has been shown to be inconsequential for particles much smaller than the acoustic wavelength, instead the gradient effects dominate. In a tightly focused traveling wave acoustic beam, for example, it is the gradients in the sound field which pushes particles away from its centreline in the same way particles are driven from anti-nodal to nodal positions in a standing wave. The differences between conventional standing waves and the acoustic fields as presented here are that in a standing wave the gradients follow sinusoidal distributions, whereas there is no such limitation for field gradients arising from the spatially distributed traveling wave according to various example embodiments, and that for SAW and fluid wavefronts according to various example embodiments the time average of the squared pressure and velocity components are spatially co-located; [symbol] p₁² [symbol] is at a maximum at the same location(s) as [symbol] v₁² [symbol] . These differences, however, are readily accounted for in Equation 10 and in any case (regarding the spatial co-location of pressure and velocity maxima) do not have a significant effect on the calculated force since ƒ₁ is approximately an order of magnitude larger than ƒ₂ for dense particles in water.

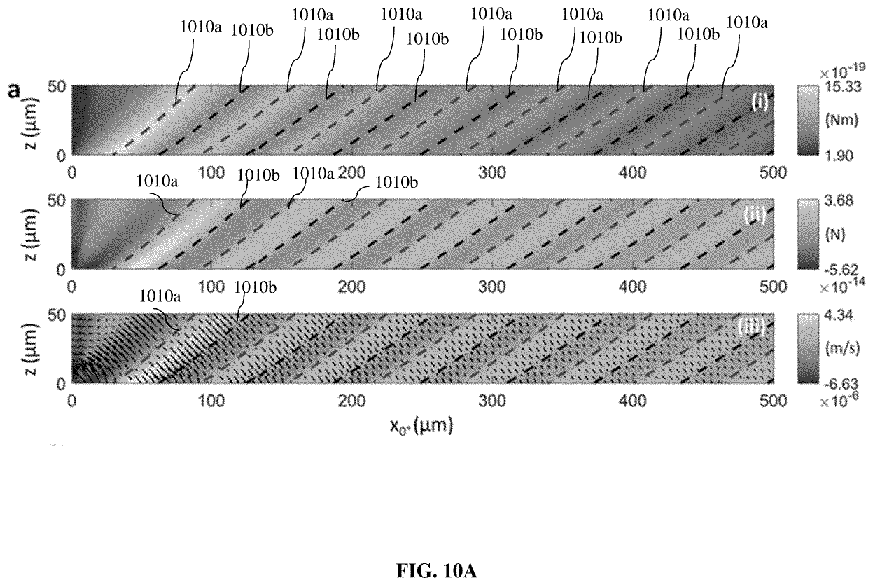

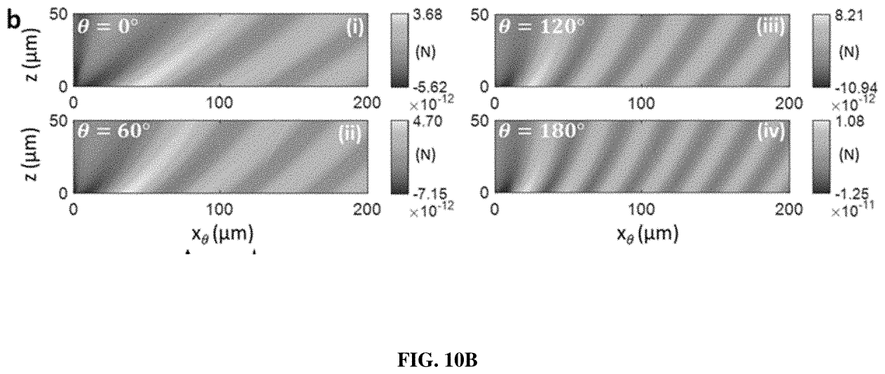

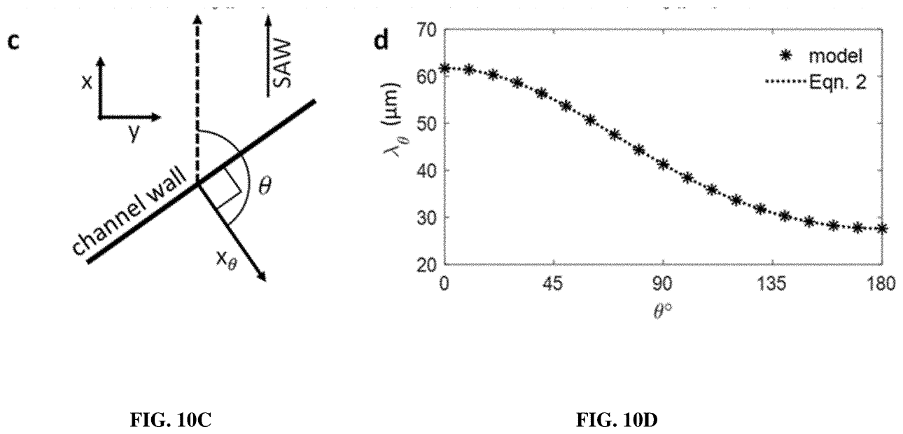

FIG. 10A examines the behaviour of U and the acoustic radiation forces experienced by suspended particles for the case θ is equal to 0°. More particularly, FIG. 10A illustrates acoustic field in the x-z plane orthogonal to channel wall in the fluid domain. The acoustic force potential U in image (i) follows the contours of time-averaged energy density, [symbol] E [symbol] , where lines 1010a and 1010b show maximum and minimum U , respectively. Image (ii) F^{rad}, with plotted lines from image (i) corresponding here to F^{rad} equal to 0 contours. Image (iii) illustrate particle velocity plot, where arrows point in the direction of particle migration. Plots are for a 1 μm polystyrene particle diameter (ρₚ of 1050 kg/m³, κₚ of 2.5E-10 Pa⁻¹), μ of 9E-4 Pa·s, a maximum fluid particle velocity U₁ of ωξ₀ of 0.15 m/s and λ_{SAW} of 100 μm, with θ of 0°. Particles experience no acoustic radiation force as defined in Equation 10 where the gradient of U is equal to zero. Though this is the case along all dashed lines in image (i), only the lines 1010b representing the local minima of U will retain particles, as any particle position perturbations at the local maxima (dashed lines 1010a) will result in migration down acoustic force potential gradients. Note that U is greater than 0 even in the acoustic fringe minima, as acoustic energy is still contained within the planar vₛ wavefronts that interfere with the fluid wavelets (whose magnitudes given by v_{c} are uniformly smaller than vₛ). It is the energy density gradient rather than its absolute magnitude that ultimately results in particle motion. These lines of zero U are equivalent to the iso-force lines mapped in image (ii) of FIG. 10A, where positive values are oriented in the +x_{0°}. direction. Particles migrate due to both positive and negative forces along the direction force vector field F_{rad} towards the iso-force lines at potential field minima. Setting the fluid drag equal to the acoustic radiation force, the particle migration velocities are given as follows.

vₚ=F^{rad}(6πμα)⁻¹ Equation (11)

where vₚ is the particle velocity and p. is the fluid viscosity.

The plot in image (iii) of FIG. 10A illustrates the magnitude and direction of particle migration according to the forces plotted in image (ii). In a physical device with a channel roof, the acoustic field will necessarily be altered as partially reflected wave components will similarly result in acoustic force potential gradients in the z-direction, though by using a channel material such as the polydimethylsiloxane (PDMS) utilized here with only a ˜4% reflection coefficient, the force and velocity magnitudes presented here are broadly representative of the rendered devices. In any event, the fringe spacing perpendicular to the channel walls is maintained. While the images here are representative of a particular set of specific particle properties, changes in the acoustic conditions will lead to different acoustic radiation force magnitudes without changes in the overall contour plot morphology, with Ξ∝v₁ and vₚ∝F^{rad}∝ [symbol] E [symbol] ∝v₁². For example, the maximum μm/s-order particle velocities shown in image (iii) of FIG. 10A for U₁=0.15 m/s would correspond to 100's of μm/s with U₁=1.5 m/s, where U₁ is the characteristic (initial, pre-attenuation) substrate displacement velocity.

FIG. 10B shows plots of F^{rad} for wall orientations of θ=0°, 60°, 120° and 180°, where the fringe spacing along the x_{θ} direction matches the spacing predicted by Equation 2. More particularly, FIG. 10B shows plots of F^{rad} (in Newtons) on a 1 μm polystyrene particle for different θ, 0°, 60°, 120° and 180° in images (i)-(iv), respectively. It is noted that the SAW propagation direction is along the +x direction, whereas these fringes are plotted along x_{θ} as depicted in FIG. 10C. For example, FIG. 10C illustrates each contour plot mapped along the x-axis x_{θ}, defined as the axis perpendicular to the channel wall. In image (iv) of FIG. 10B, for example, SAW wavefronts travel from right to left along the x_{θ} axis, representing the case where SAW wavefronts are travelling towards a channel wall placed in their path. The spacing is largest when the SAW wavefronts propagate in the same direction as the fluid wavelets (θ=0°), though the force magnitudes are largest when they are counter-propagating (θ=180°), owing to the larger acoustic force potential gradients occurring when the periodic spacing is smaller. FIG. 10D illustrates the fringe spacing (from minima to minima) along x_{θ} from this model matches the spacing from Equations 2 and 5. More particularly, FIG. 10D shows that the fringe spacing (corresponding to the distance between iso-force locations) matches the predictions from Equations 2 and 5, as measured by the distance between minima along the x_{θ} direction at z equal to 1 μm.

Because particle patterning is a result of acoustic radiation forces, the discussion of acoustic streaming is omitted, which will nevertheless occur and generate particle forces via fluid drag. The particular fluid velocities that result, however, are a function of the channel geometry. The relationship between this geometry, actuation mode, frequency, streaming velocity and their effects on particle migration have been discussed in detail in the art. In the systems considered here, the acoustic radiation forces necessarily exceed those arising from fluid drag for particle patterning in acoustic fringes to be observed. The effect of acoustic travelling waves on particle migration have been ignored here, as the effect of the stationary field is many orders of magnitude larger when R«λ. Moreover, a travelling wave component would serve to drive denser particles in the direction of acoustic propagation, rather than create the observed fringe patterns. Having developed an analytical model that demonstrates the generation of acoustic forces resulting from a spatially limited transducer, it is shown that these forces can be used to create fringe patterns in a physical system or device.

### Methodology

In various example embodiments, by way of an example only and without limitation, each SAW device comprises a series of interdigitated transducer (IDT) electrodes patterned on a 128° Y-cut, X-propagating piezoelectric lithium niobate (LiNbO₃) substrate. A SAW device is characterized by its wavelength, λ_{SAW}, defined as the spacing between periodic IDT features. The applied harmonic frequency is such that the substrate deflections emanating from one set of IDT finger-pairs (at cₛ) are reinforced by the neighbouring ones, with ƒ=cₛ/λ_{SAW}, and results in a travelling SAW on either side of a bidirectional IDT. To ensure maximum wavefront uniformity in the target region, the λ_{SAW}=80 μm IDTs used in an example embodiment are 14 mm wide, larger than the channel in which shaped channel features are placed. Wave absorber (First Contact Polymer, Photonic Cleaning Technologies, WI, USA) was used on the reverse side of the IDT and on the opposite side of the channel region to minimize spurious reflections.

According to various example embodiments, 22-μm-high channel features were defined using conventional SU-8 photolithography (SU-8 2025, Microchemicals, Germany) and created from soft-lithographic polydimethylsiloxane (PDMS) molding from the SU-8 master, whose patterns are shown in FIG. 1C. The completed channels were aligned and attached to the SAW device using plasma bonding (e.g., Harrick Plasma PDC-32G, NY). Fluorescent 1-μm-diameter polystyrene particles (Magsphere, Calif.) are used to trace the locations where both the acoustic radiation force is zero and the acoustic potential field is at a minimum, as shown by the black dashed lines in FIG. 10A. A sound speed of 1540 m/s for the water-particle mixture is utilised in an example embodiment based on a 0.05% polystyrene particle volume fraction according to a Wood equation, as described in Chambre, P. L. Speed of a Plane Wave in a Gross Mixture. J. Acoust. Soc. Am. 26, 329-331 (1954), and a 40° C. solution temperature. This temperature is based on thermal imaging measurements (e.g. using FLIR i5, FLIR Systems Australia) and an applied power of 0.5 W.

Pressure fields are simulated according to a programmed implementation of the Huygens-Fresnel Principle, where the magnitude of the pressure field at a given point in the fluid is the integral of all spherical wave sources from the transducer plane. Channel walls enclosing a finite area affect the acoustic field within by spatially limiting the effective transducer area that can contribute to the pressure field. Accordingly, the effect of circular pillar-shaped channel walls are simulated by defining a masked circular region in which the substrate displacement is zero. Details of the simulation process is described in detail in O'Rorke, R., Collins, D. & Ai, Y. A rapid and meshless analytical model of acoustofluidic pressure fields for waveguide design. Biomicrofluidics 12, (2018). Each contributing pixel in the transducer plane has dimensions of 1/50 λ_{SAW} in the x and y-directions, is simulated across a domain with dimensions of at least 12 λ_{SAW} by 12 λ_{SAW} and is evaluated immediately above the transducer plane (z=1 μm) for a SAW wavelength of 80 μm. Each simulation removes boundary effects in the fluid (i.e., that arise from the channel wall in the path of the SAW) by subtracting the pressure magnitude in the case where there is no simulated pillar feature.

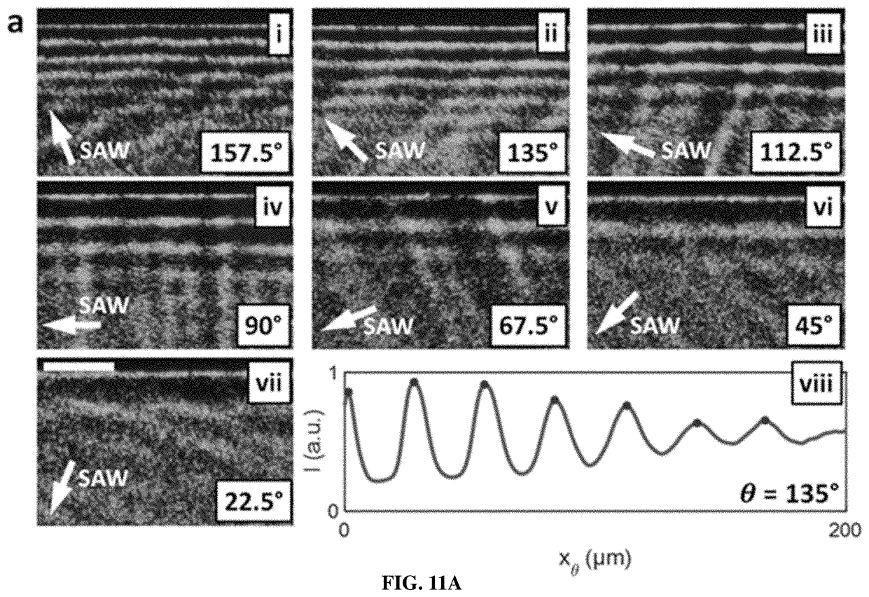

The interference patterns arising from channel features are examined and compared with the predictions made in the analytical models. These patterns are visualized using polystyrene microparticles, which align at the acoustic force potential minima as shown in FIGS. 11A-11C. The experimental setup to test the predictions made by Equation 2 (and 5) is performed with flat channel interfaces that are set at select angles with respect to the SAW propagation direction. FIGS. 11A-11C illustrate this periodicity near (or around) a channel wall placed in the path of a SAW. More particularly, FIGS. 11A-11C illustrate patterning spacing in near a flat wall. FIG. 11A highlights the individual angles with interface orientations of 22.5°, 45°, 67.5°, 90°, 112.5°, 135° and 157°, each of which comprises a pair of 1,800 μm long, 160 μm wide PDMS channel walls that are bonded to the substrate at each of these orientations, according to various example embodiments. More particularly, FIG. 11A show experimental images rotated to the channel wall frame of reference. White arrow shows the orientation of the underlying travelling SAW, here for wall angles of (i) 157.5°, (ii) 135°, (iii) 112.5°, (iv) 90°, (v) 67.5°, (vi) 45° and (vii) 22.5°. Scale bar of images is 100 μm. The mean fringe spacing is calculated from the distances between maximum optical intensity peaks along the axis perpendicular to the interface, x_{θ}, with an example measurement shown in graph (viii) of FIG. 11A. The graph (viii) shows the optical intensity for an example measurement (135°), with dots at each measured peak. The intensity values are computed as the average of the horizontal pixels in each of (i-vii). Error bars show ±1 standard deviation from the mean measured value. Taking measurements of these spacings for each angle in (a) these results are compared with Equations 1 and 2. The spacings from FIG. 11A are overlaid on the predictions from Equations 1 and 2 in FIG. 11B, plotted as the ratio between the spatial periodicity at a given angle and the SAW wavelength (λ_{θ}λ_{SAW}⁻¹). The error bars here represent one standard deviation of the measured spacings (i.e. the distances between red dots in (viii)). Values of θ less than 90° are measured on the opposite pillar side (farther from the SAW source) and θ more than 90° are measured on the proximal side, as illustrated in FIG. 11C. The scale bar is 200 μm. One set of pillars is used to make two measurements on either side, here showing an example at 45° and 135°. The value for θ is measured from the SAW propagation direction (θ of 0°).

It has been shown in the literature that the periodicity of the acoustic field evolves in the z-direction, as the acoustic energy maxima projects into the fluid at the Rayleigh angle θ_{R} (about 23° for H₂O/LiNbO₃) close to the channel interface and approaches

$${θ}_{n f} = \frac{1}{2} {cos}^{- 1} [ \frac{{c}_{l}}{{c}_{s}} ]$$

(about 34°) with increasing distance from it. Considering that a nodal position develops one half λₗ from the PDMS-water roof interface in the z-direction, this results in an elongated periodicity at the trapping height. Therefore, Equations 1 and 2 have been accordingly modified to account for trapping of physical particles at a positive and finite position in the z-direction, with λ_{θ}=λ_{θ(z=0)}+ε. For a channel height of 22 μm, this predicted trapping height occurs at z=7 μm, resulting in a difference (increase) of ε=1.7 μm between these two angles at this height, or approximately 2% of λ_{SAW}. Though the difference is small, this correction factor in included for completeness when making comparisons with the experimental results.

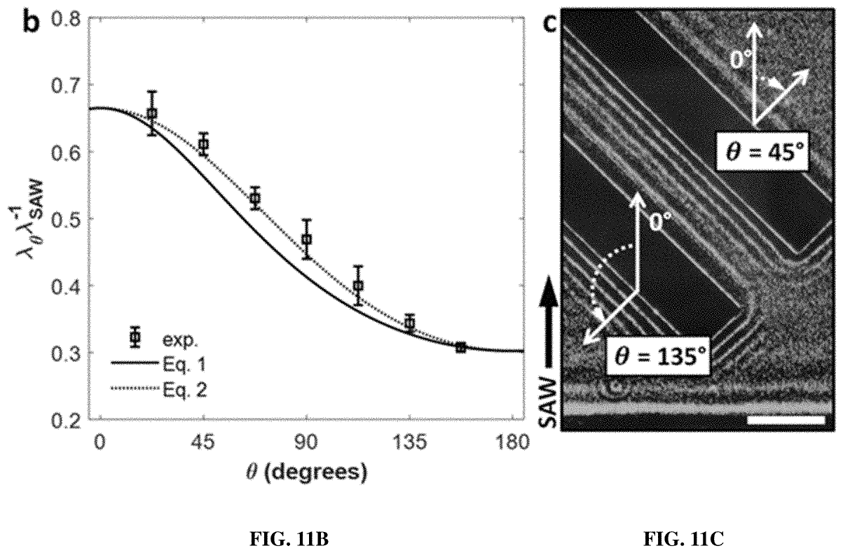

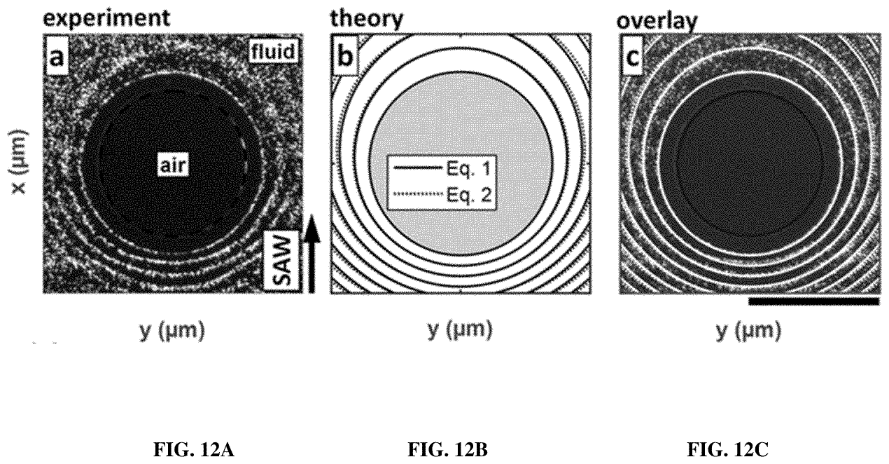

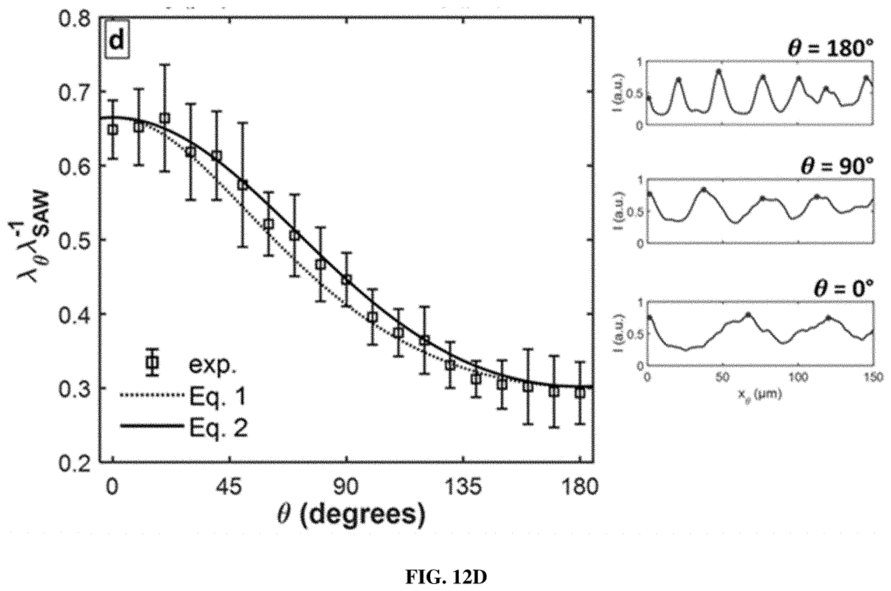

Comparing the flat and infinite curvature model predictions, the overall relationships between angle and periodic fringe spacing are similar, with increasing divergence for intermediate interface angles. The measured spacings in FIG. 11 for flat channel features match well with the predictions from the flat wall model (Equations 2) and are uniformly higher than those predicted by Equation 1.

Whereas matching the flat wall condition from Equation 2 is straightforward to set up experimentally, the condition where R→0 is not as straightforward, as the magnitude of the scattered wavefronts decreases with smaller values of Rλ_{SAW}⁻¹. Accordingly, for Equation 1 to be probed experimentally the interface radius should be sufficiently large that particle aggregation can occur and so that effects from other channel walls, non-SAW wave components and reflections in the larger channel do not dominate particle migration behaviour. Though the patterning effect is less pronounced than in the flat wall case, it is still nevertheless observable for the entire 360° arc around a 400-μm-diameter cylinder interface, with Rλ_{SAW}⁻¹=2.5, as shown in FIG. 12A, albeit weakly for values of θ close to 0°. More particularly, FIG. 12A illustrates a SAW produces an ellipsoidal interference pattern near a circular channel interface. Black dashed line denotes internal (air-filled) channel boundary. FIG. 12B shows the modelled periodic patterning locations around this cylinder, with each subsequent patterning ellipsoid spaced λ_{θ} from the previous one for a given value of θ. More particularly, the predicted periodicity from Equations 1 and 2 from a circular channel interface (interior colored gray) with a diameter of 400 μm. Predicted patterns from Equations 1 and 2 are overlaid on the experimental condition in FIG. 12C, in part to highlight their similarity and the difficulty in determining the exact value of λ_{θ} experimentally. The scalebar of FIGS. 12A-12C is 300 μm. FIG. 12D shows the mean value taken across three separate experiments for 10° increments in θ, where the error bars denote ±1 standard deviation from this value across all measured values for that angle. The inset shows optical intensity profiles for selected angles (θ of 0°, 90° and 180°). The measured periodicity for this intermediate sized-object is between the two predictive models, which are for the extremes of a pillar with R→0 (Equation 1) and a flat interface (Equation 2). The error bars here represent one standard deviation of the measured spacings (i.e. the distances between dots in the graphs on the right). The right graphs show three representative optical intensity profiles measured from the edge of the interface (at θ of 0°, 90° and 180°). Though the sizable error bars are inherent for low scattering amplitudes with a channel interface radius on the order of λ_{SAW}, their mean values may be inferred to be lower than both those measured in the case of a flat wall interface (illustrated in FIG. 11B) and the predictions from Equation 2. While these experimental conditions are valuable in demonstrating that wall interfaces subject to SAW yield consistent and robust patterning behaviour, the magnitude of the error bars (including for image (i) in FIG. 4B, whose measured periodicity is illustrated with respect to FIG. 5A) for these cases requires a more rigorous approach to comprehensively explore the effect of interface curvature.

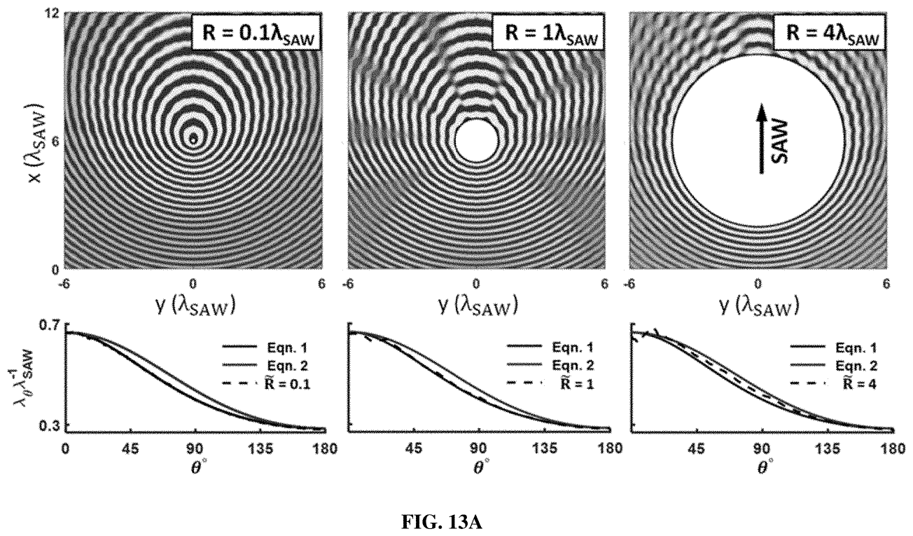

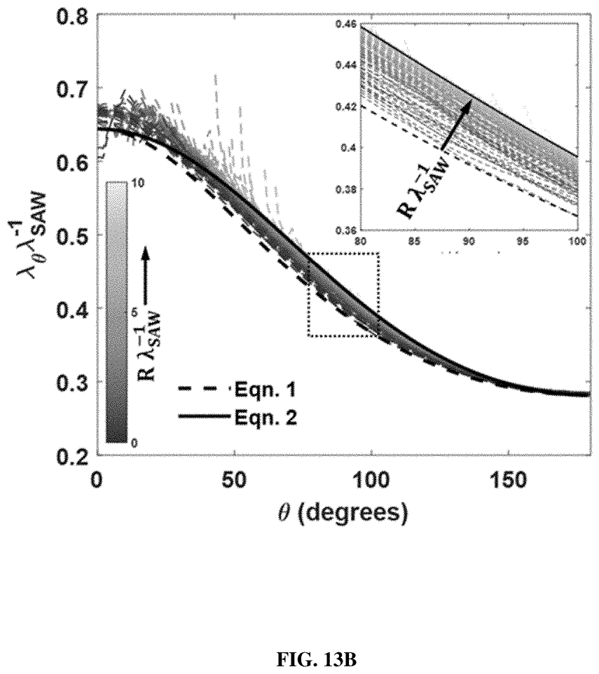

Having established that the models as described are broadly predictive of acoustic periodicity in the experimental cases examined, the effect of channel interfaces in simulated and modelled conditions are now examined in which effects imposed by heating, acoustic streaming, fluid flow, reflected waves, Brownian motion and unintended substrate vibration modes that may also modify the spatial force distribution on suspended particles in an experimental setup are excluded. FIG. 13A shows the effect of increasing radial dimensions on the resulting periodicity, with representative simulation plots for R equal to 0.1 λ_{SAW}, 1 λ_{SAW}, 4 λ_{SAW} and periodic fringe spacing plots for angles between 0° and 180°. More particularly, FIG. 13A shows simulated periodicity in the fluid domain. Pressure field [symbol] p₁² [symbol] resulting from a circular pillar interface (white circle) in the path of a travelling SAW for pillar radius R=(0.1, 1, 4)λ_{SAW} for the case where cₗcₛ=0.4. Graphs below each simulation figure plot the periodicity from each of these for 0°≤θ<180°. These simulation images are chosen to demonstrate the change in fringe spacing with increasing channel pillar radius. The periodicity is assessed by measuring the distance between neighbouring peaks in the pressure amplitude profile along a specified angle at 0.1° intervals. At the lower limit (R→0) the simulated periodicity closely matches the case predicted by λ_{θ}^{(R→0)}, with larger pillar dimensions increasing the resulting periodic spacing for a given value of θ. For R equal to 0.1 λ_{SAW} the measured periodicity is equivalent to the equation for λ_{θ}^{(R→0)} whereas for R equal to 4 λ_{SAW} it is intermediate between the predictions from the equations for λ_{θ}^{(R→0)} and λ_{θ}^{(R→∞)} (Equations 1 and 2, respectively).

While the relationship between periodic spacing and increasing R is apparent in these simulation results, which are useful in confirming the variation in periodic spacing as a function of θ as well as the increasing values of λ_{θ}^{(R→∞)} for increasing R, the measured periodic spacing does not clearly follow the predicted trendlines at values of θ closer to 0°, as shown in FIG. 13B. This is ultimately a result of the interference lobes that can be seen in FIG. 13A, especially apparent for smaller values of θ. These arise from wave contributions on the near (SAW-source) side of the pillar. In the simulation, the wavefield magnitude at every point in the field is computed as the sum of radially expanding wavefronts from every point on the substrate. Wavefronts propagate freely across the channel interfaces in the simulation and attenuation in the material is not considered, which is not the case experimentally. While this simulation model is useful in illustrating the bulk effects of a circular pillar wall on the surrounding acoustic field, an alternative model is required to clearly show the transition between Equation 1 and Equation 2 for increasing R.

FIG. 13B shows a graph illustrating simulated values of λ_{θ} relative to λ_{SAW} according to the model presented in FIGS. 11A-11C. The graph here shows the transition between predictions made by Equation 1 and Equation 2 for Rλ_{SAW}⁻¹=0.1 to Rλ_{SAW}⁻¹=10 and \tilde{c}=0.4, though predictions are relatively non-uniform relative to those arising from the quasi-analytical method, especially for smaller values of θ. This is due to the influence of interference lobes that can be observed in the simulations described with respect to FIGS. 11A-11C.

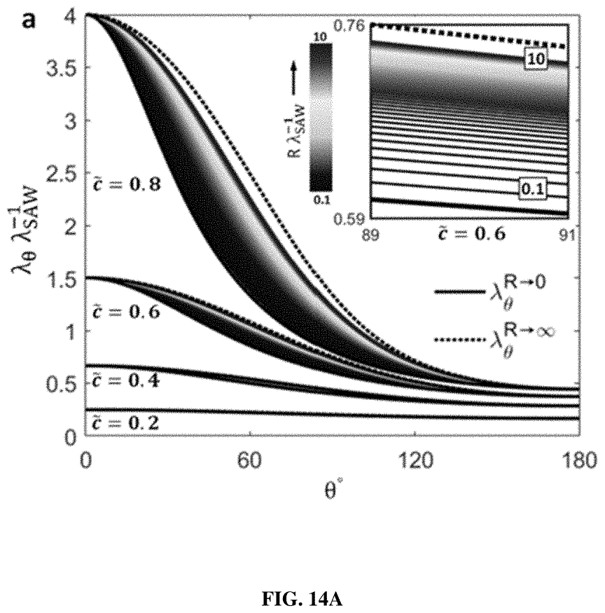

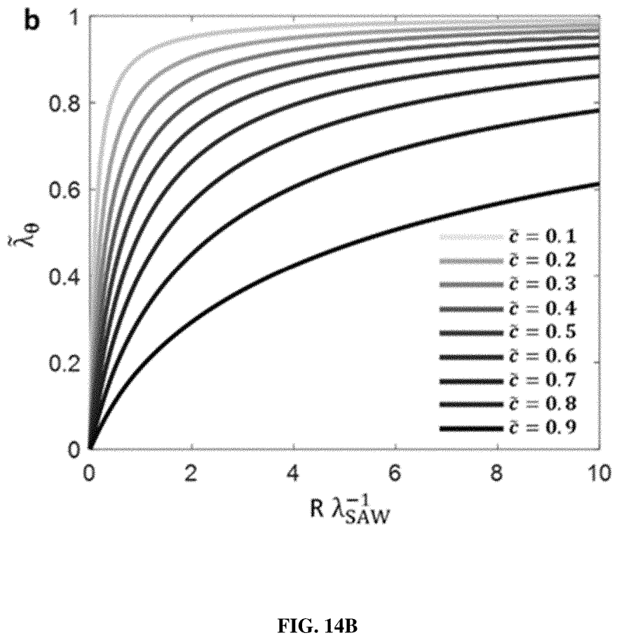

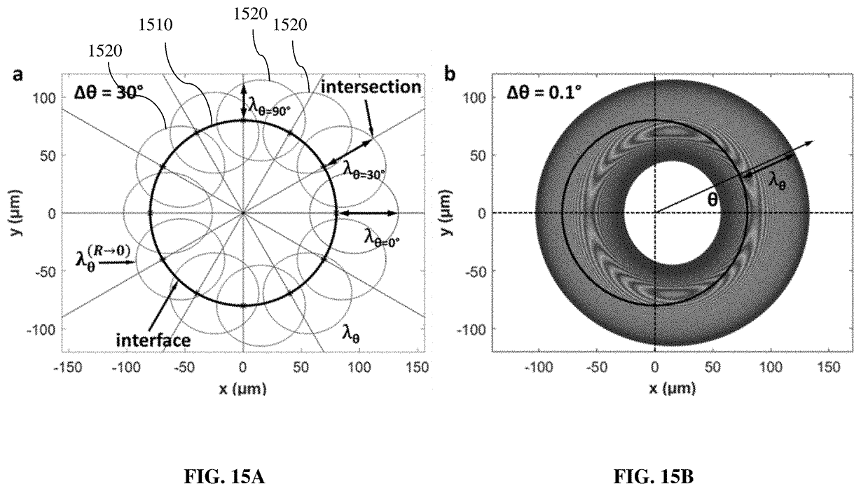

FIGS. 14A-14B introduce the results of such a model, which applies the Huygens-Fresnel principle to Equation 1. More particularly, FIGS. 14A-14B illustrate the effect of sound speed on transition between Equation 1 and Equation 2. FIG. 14A depict a plot of periodicity for pillar elements with R=0.1 λ_{SAW} to R=10 λ_{SAW} in increments of 0.1 λ_{SAW}, for sound speed ratios \tilde{c}=cₗ/cₛ=0.2, 0.4, 0.6 and 0.8. Inset shows increasing periodic lengths for for increasing Rλ_{SAW}⁻¹, here for \tilde{c}=0.6. FIG. 14B depict the modelled transition rate between the two extreme cases (where \tilde{λ}_{θ}=0 and \tilde{λ}_{θ}=1 corresponds to λ_{θ}^{R→0} [Equation 1] and λ_{θ}^{R→∞} [Equation 2]) decreases as \tilde{c}→1, here examined for θ=90°. These spacings are obtained from the model methodology outlined with respect to various example embodiments of the microfluidc device such as shown in FIG. 1C. Every point on the surface of the channel interface will result in its own interference ellipsoid owing to the circularly expanding fluid wavelets from that point. This model is illustrated graphically in FIGS. 15A-15B, which shows that by arbitrarily decreasing the distance between neighbouring fluid wavelet point sources on the pillar, the distance between the pillar surface and where these ellipsoids maximally intersect can be readily determined. This is examined in a MATLAB model by plotting these ellipsoids along the edge of the interface. Using this model, periodicity evolution for increasing pillar radius may be accurately examined. More particularly, FIGS. 15A-15B illustrates increase in periodic spacing above that predicted by Equation 1 for finite-sized objects. FIG. 15A demonstrates that the evolved time-averaged field around an object (black circle 1510) can be composed of the sum of intersection ellipsoids (as in FIG. 6A) from every point on the object surface according the Huygens-Fresnel principle. Circles 1520 show the ellipsoids for a select number of points. The value of is given by distance between the object surface and the outermost intersection of a radial line with any intersection ellipsoid. To clearly show the methodology intersection ellipsoids are plotted every 30°. FIG. 15B depicts the accurate determination of λ₇₄ is enhanced for decreasing Δθ between plotted ellipses, here with Δθ=0.1°.

Referring back to FIG. 14A, it shows the transition between the predictive models where λ_{θ}^{(R→0)} and λ_{θ}^{(R→∞)}, with increments of 0.1Rλ_{SAW}⁻¹, where Rλ_{SAW}⁻¹ is the radius value normalized by the SAW wavelength, between 0.1≤Rλ_{SAW}⁻¹≤10 and for sound speed ratios (\tilde{c}=cₗ/cₛ) of \tilde{c}=0.2, 0.4, 0.6 and 0.8. The periodic spacing value λ_{θ}λ_{SAW}⁻¹ is similarly normalized by the SAW wavelength. It is noted that the difference between the predictive models is increased for intermediate values of θ and for \tilde{c}→1, and where increasing values of Rλ_{SAW}⁻¹ result in values of λ_{θ} that asymptotically approach λ_{θ}^{(R→∞)}. To examine the trajectories between these models as a function of \tilde{c} more closely while isolating the effect \tilde{c} has on the overall difference between Equation 1 and Equation 2, it is appropriate to determine the relative value of λ_{θ} between λ_{θ}^{(R→0)} and λ_{θ}^{(R→∞)}. This relative value may be determined as follows.

$${\tilde{λ}}_{θ} = \frac{{λ}_{θ} - {λ}_{θ}^{( R \to 0 )}}{{λ}_{θ}^{( R \to ∞ )} - {λ}_{θ}^{( R \to 0 )}} \qquad Equation ( 12 )$$

FIG. 14B therefore examines the trajectory of \tilde{λ}_{θ} at the value of θ equal to 90° for increasing \tilde{c}. Regardless of the specific value of θ, however, the relationship between \tilde{λ}_{θ} and \tilde{c} remains the same. Values of cₗ that approach cₛ result in a less rapid shift from the λ_{θ}^{(R→0)} model to the λ_{θ}^{(R→∞)} one. FIG. 14B is important for determining the relative importance of Equations 1 and 2 for a given experimental case. In the case of the lithium niobate (cₛ of 3931 m/s) and water combination used here, similar to \tilde{c} of 0.4, Equation 2 is broadly predictive of the periodicity for radii of curvature greater than 2 λ_{SAW} (\tilde{λ}_{θ}≈0.8). A slower propagation velocity in piezoelectric substrate materials such as polyvinylidene fluoride (PVDF, cₛ of 2200 m/s, \tilde{c} of about 0.7), however, requires a radius of R more than 6 λ_{SAW} to yield a similar dominance of Equation 2 (\tilde{λ}_{θ}≈0.8). Moreover, there is increasing discrepancy between the predictive models for larger values of \tilde{c} generally. In this case it is important to use Equation 12 to generate periodicity predictions, especially for microchannel features whose dimensions are on the order of a few SAW wavelengths or less.

Accordingly, channel interfaces according to various example embodiments placed in the path of a travelling SAW may produce robust interference patterns. Various expressions have been provided to predict the spacing of these acoustic fringes, which are corroborated by an analytical model, experiments and simulations. Simulations and theoretical analysis based on the Huygens-Fresnel principle, in which spurious effects from streaming, reflections and secondary wave modes are avoided, provide evidence for the prediction that larger periodic spacings result as Rλ_{SAW}⁻¹→∞. The differences between the predictive models are increase for fluids with sound speeds approaching that of the underlying substrate, and thus are an important consideration when predicting periodic spacings, though amount to less than 10% for the combination of water on lithium niobate used in example embodiments described above. Diffractive patterning periodicity in microfluidic systems may be predicted based on novel physically-derived equations as described, with the predictions made by these equations (and the counter-intuitive result that patterning periodicity is a function of surface curvature) being supported by the confluence of the multitude of approaches utilized. This includes calculation of acoustic fields in the x-z plane (as described with respect to FIGS. 10A-10D), experimental results as described with respect to FIGS. 11A-11C and FIGS. 12A-12D, simulations in the x-y plane (as described with respect to FIG. 13A), and analysis of the transition behaviour between the derived analytical models (Equations 1 and 2). Taken together these present a comprehensive disclosure of 2D diffractive patterning activities in microfluidic systems in a way that has not been previously demonstrated.

The channel interface method for generating particle patterns has substantial advantages over conventional methods for generating acoustic radiation force fields with SAW, which typically create uniform standing waves across the entire IDT aperture. Because these interfaces can be placed arbitrarily within a microfluidic channel and their effect on the surrounding force field is spatially limited, these channel interfaces permit localized and flexible microfluidic manipulation. In comparison to other techniques such as the generation of spatially localized acoustic fields in a pulsed SAW time-of-flight regime, channel interfaces according to various example embodiments permit force gradients at any angle to the SAW wavefront and with the imposition of only a single travelling wave.

The interface-based methodology according to various example embodiments may be expanded to a range of acoustofluidic activities that can be performed on-chip. While the models developed and provided are specific to microfluidic devices actuated by SAW, the approach of applying Huygens-Fresnel principles according to various example embodiments has a wide utility in providing future predictions for diffractive-based acoustic micromanipulation in other systems.

### Derivation of Equation (1)

Equation (1) may be regarded as the answer to a simple question: if a fast moving wavefront is catching up with a slower moving one, how long will it take them to intersect? This intersection is the point at which these wavefronts will constructively interfere. Because the scattered fluid wavefront travels at a velocity of cₗ (˜1500 m/s, water), which is less than that of the SAW wavefront travelling at cₛ (˜4000 m/s, water), this intersection will occur when the SAW wavefront overtakes the fluid wavefront. This distance is referred to as λ_{θ}, or the distance between the effective source of a fluid wavefront (a channel/fluid interface, for example) and the point at which a SAW wavefront interferes with it.

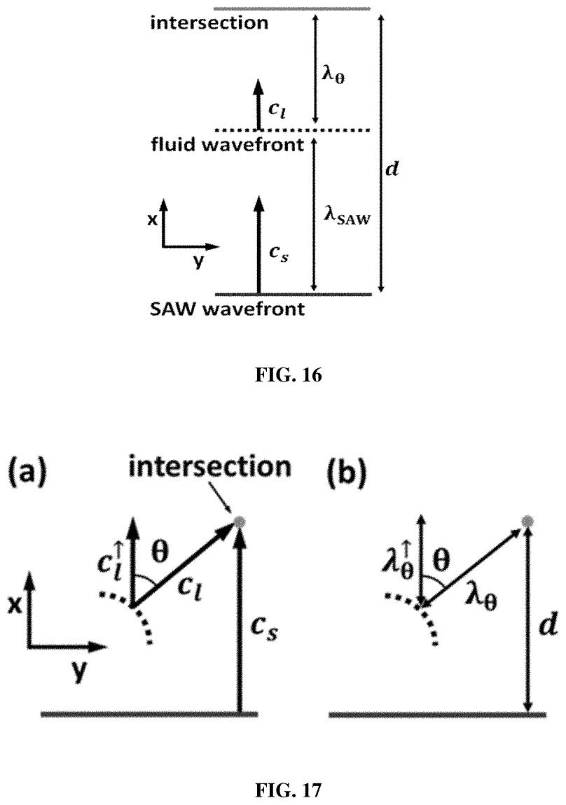

In a simplified case where both wavefronts are travelling in the same direction as illustrated in FIG. 16, λ_{θ} may be solved with the knowledge that they intercept at time t from the initiation of the fluid wavelet as follows.

$$t = \frac{{λ}_{θ}}{{c}_{l}} = \frac{d}{{c}_{s}} \qquad Equation ( S 1 )$$

Since d=λ_{θ}+λ_{SAW} when both waves are travelling in the same direction, the following may be obtained.

$$\frac{{λ}_{θ}}{{c}_{l}} = \frac{{λ}_{θ} + {λ}_{S A W}}{{c}_{s}} = \frac{{λ}_{θ}}{{c}_{s}} + \frac{{λ}_{S A W}}{{c}_{s}} , \qquad Equation ( S2 )$$

By grouping all λ_{θ} terms, the following may be obtained.

$${λ}_{θ} ( \frac{1}{{c}_{l}} - \frac{1}{{c}_{s}} ) = \frac{{λ}_{S A W}}{{c}_{s}} , \qquad Equation ( S3 )$$

λ_{θ} may be solved as follows.

$${λ}_{θ} = \frac{\frac{1}{{c}_{s}} {λ}_{S A W}}{\frac{1}{{c}_{l}} - \frac{1}{{c}_{s}}} = \frac{\frac{{c}_{l}}{{c}_{s}} {λ}_{S A W}}{1 - \frac{{c}_{l}}{{c}_{s}}} , \qquad Equation ( S4 )$$

An expression for λ_{θ} is obtained in terms of the known quantities cₛ, cₗ and λ_{SAW}. Since the fluid wavelength is given by

$${λ}_{1} = \frac{{c}_{l}}{{c}_{s}} {λ}_{S A W} ,$$

this expression becomes

$${λ}_{θ} = \frac{{λ}_{1}}{1 - \frac{{c}_{l}}{{c}_{s}}} , \qquad Equation ( S5 )$$

In this case, the θ in λ_{θ} is 0° because the SAW wavefront and fluid wavefront are propagating in the same direction. Various example embodiments seek to generalize this model for any orientation of the SAW wavefronts with respect to the source of the fluid wavelets from a channel interface. At the limit where the radius of curvature approaches zero, as in Rayleigh scattering, the wavelets take the form of expanding circular wavefronts. Calculating the distance between the wavelet source and its intersection with a SAW wavefront for a given value of θ must then take into account that the velocity component of the fluid wavefronts in the +x direction (cₗ^{↑}), which will be decrease with increasing θ. FIG. 17 shows this scenario expressed in terms of either (a) velocity or (b) distance. For a time period equal to

$$t = \frac{d}{{c}_{s}} = \frac{{λ}_{θ}}{{c}_{l}} = \frac{{λ}_{θ}^{↑}}{{c}_{l}^{↑ ′}} ,$$

the length of the (a) velocity vectors and (b) distances are equal. The value of cₗ^{↑} is given as follows.

cₗ^{↑}=cos(θ)cₗ. Equation (S6)

Substituting this value into Equation (S4), an expression for the vertical (+x direction) component of λ_{θ} may be obtained as follows.

$${λ}_{θ}^{↑} = \frac{\frac{{c}_{l}}{{c}_{s}} cos ( θ ) {λ}_{S A W}}{1 - \frac{{c}_{l}}{{c}_{s}} cos ( θ )} = \frac{cos ( θ ) {λ}_{1}}{1 - \frac{{c}_{l}}{{c}_{s}} cos ( θ )} , \qquad Equation ( S7 )$$

Noting that

$${λ}_{θ} = \frac{{λ}_{θ}^{↑}}{cos ( θ )} , \qquad Equation ( S8 )$$

Equation (1) as described above it obtained as follows

$${λ}_{θ} = \frac{{λ}_{1}}{1 - \frac{{c}_{l}}{{c}_{s}} cos ( θ )} \qquad Equation ( S9 )$$

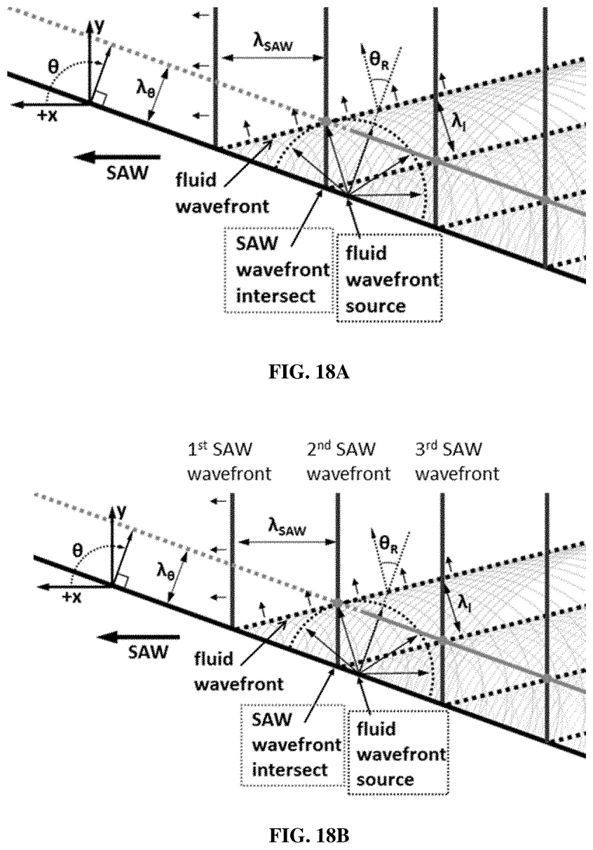

This expression is valid for the case where the second SAW wavefront intersects with the first fluid wavefront at the same time the third SAW wavefront arrives at the origin of the first fluid wavefront. Further, this expression is valid when the effective radius of curvature for a channel wall approaches zero (R<λ), as in the case of a pillar or post smaller than the acoustic wavelength. In the case of a flat channel wall, however, this is not the case in examining FIG. 6B in detail with respect to FIGS. 18A-18B as follows.

As shown in FIGS. 18A-18B, the intersection of the SAW wavefront along the channel wall is displaced from the source of the spherical wavefronts that ultimately intersected with that SAW wavefront. Because of this displacement, the time to fluid and SAW wavefront intersection (as described with respect to FIG. 16 and Equation (S1) will change, and requires the consideration of a separate model to determine the value of λ_{θ} for flat channel walls.

### Derivation of Equation (2)

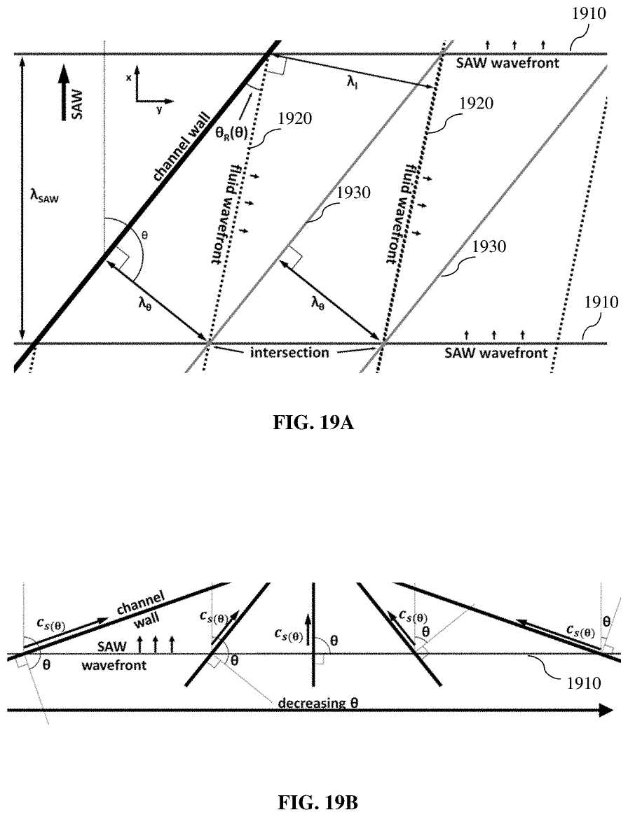

Referring to FIG. 19, a travelling SAW produces a SAW wavefront 1910 that propagates at cₛ when viewed in the plane of the transducer, whilst the intersection of this wavefront with a channel feature (in this case a flat wall) generates Huygens-Fresnel wavelets which give rise to a fluid wavefront 1920 that propagates at an angle θ_{R} to the normal vector of the wall. The interference of these wavefronts produces a new field 1930 with periodicity λ_{θ}, as illustrated in FIG. 19A. Important parameters here include the distance between SAW wavefronts (λ_{SAW}), the wavelength in the fluid (λ₁) and the angle of the channel wall relative to the SAW propagation direction θ. The value of θ_{R}(θ) is a function of the angle at which the SAW wavefronts 1910 intersect the channel wall. The velocity at which the wavefront travels along the axis of the wall is minimized (and equal to cₛ) when θ=π/2 and approaches infinity for θ values of 0 and π, and is given by

$${c}_{s ( θ )} = \frac{{c}_{s}}{sin ( θ )} .$$

This change in effective c_{s(θ)} as a function of θ is illustrated in FIG. 19B, where a SAW wavefront 1910 has a higher velocity along the channel wall for more oblique angles. Noting that this effective cₛ is a function of θ, the Rayleigh angle as a function of the channel wall angle is given as follows:

$${θ}_{R} ( θ ) = {sin}^{- 1} ( \frac{{c}_{l}}{{c}_{s}} sin θ ) . \qquad Equation ( S10 )$$

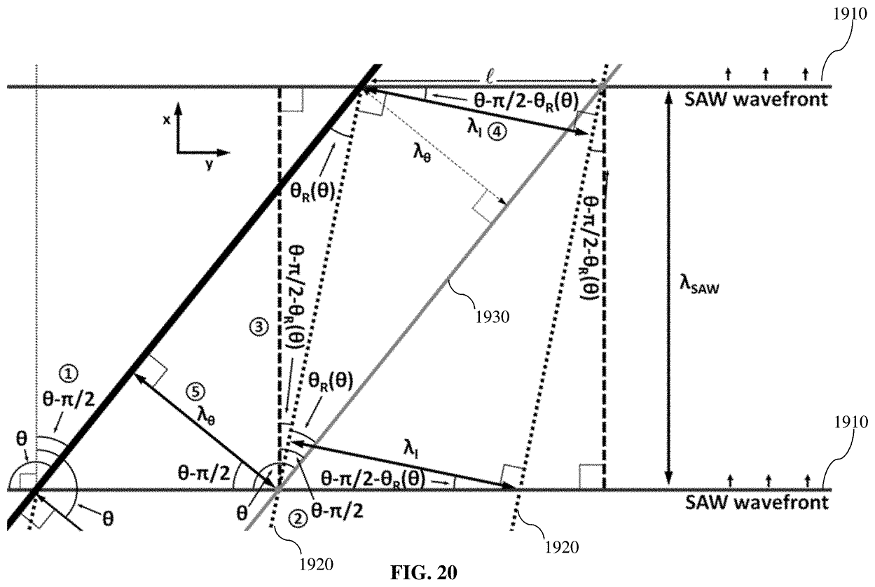

Based on the diagram in FIG. 19A, the challenge is to determine the value of λ_{θ} from the geometries in this system. To do so the value for one of the lengths of the triangle bounded by the SAW wavefront, intersection line and the line marked λ_{θ} above in FIG. 19A is determined. This line is marked [symbol] in FIG. 20. The details of the geometric considerations involved is as follows.

To find [symbol] , the diagram in FIG. 20 is populated with angles defined in terms of the known quantities θ and θ_{R}(θ). (i) First, it is noted that the angle between the channel wall and the x-axis is equal to θ-π/2. (ii) Translating this known quantity to the right, this angle and θ_{R}(θ) may be used to (iii) find the angle between the x-axis and the dotted line 1920 representing the fluid wavefront, given by θ-π/2-θ_{R}(θ). Noting that the combination of the lines denoting λ₁ and the fluid wavefronts constitute a rotated rectangle within a rectangle comprised by the dashed lines and SAW wavefronts 1910, (iv) the angle shown adjoining the line [symbol] is also given by θ-π/2-θ_{R}. Since the fluid wavelength is a known quantity, the value of [symbol] is simply given by

$$ℓ = \frac{{λ}_{l}}{cos ( θ - π / 2 - {θ}_{R} )} . \qquad Equation ( S11 )$$

(v) λ_{θ} may then be determined using

λ_{θ}= [symbol] cos(θ−π/2). Equation (S12)

Accordingly, the expression for λ_{θ} in terms of know quantities may be determined as follows.

$${λ}_{θ} = \frac{{λ}_{l}}{cos ( θ - π / 2 - {θ}_{R} )} cos ( θ - π / 2 ) . \qquad Equation ( S13 )$$

Given cos(θ-π/2)=sin(θ), this is equivalent to

λ_{θ}=λₗsin(θ) csc(θ−θ_{R}). Equation (S14)

Substituting Equation (S10) for θ_{R}, the expression for acoustic force periodicity is obtained in terms of θ and the fluid and substrate properties, with

$${λ}_{θ} = {λ}_{l} sin ( θ ) csc ( θ - {sin}^{- 1} ( \frac{{c}_{l}}{{c}_{s}} s i n θ ) ) \qquad Equation ( S15 )$$

### Theta Definition For Arbitrary Channel Walls

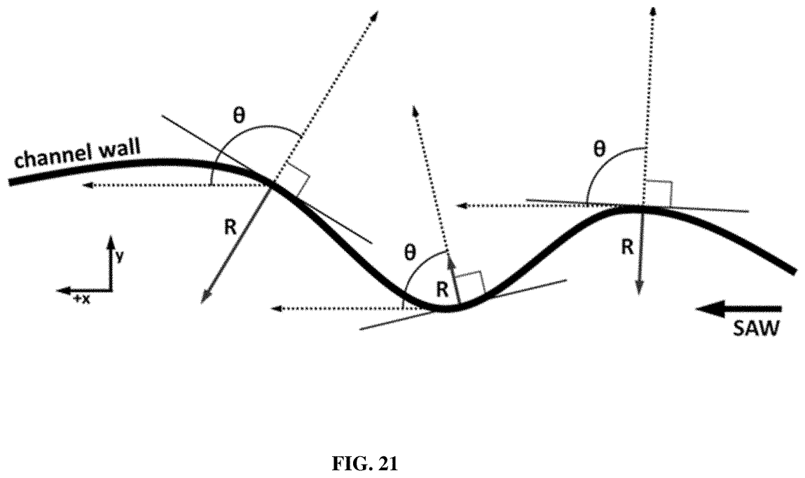

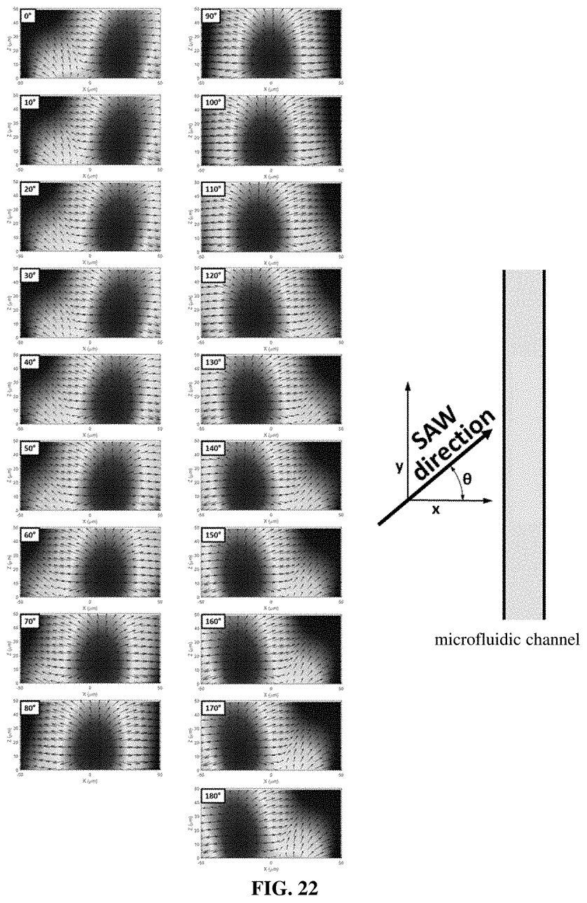

The periodicity for an arbitrary radius of curvature (between the R→0 and R→∞ cases represented by Equations 1 and 2) is described earlier above. FIG. 21 shows the transition between these two cases for finite R values as a function of the ratio of sound speeds in the fluid and substrate. For channel wall with such a curvature, the value of 0 is still defined as the angle between the direction of acoustic propagation and a line extending orthogonally from the channel wall.

### Spatial Periodicity of the Acoustic Radiation Forces

Referring back to FIGS. 4A-4B, it can be seen that the spacing between particle lines is longer for some channel wall orientations than for others. A model that predicts this periodic spacing for low channel heights has been developed. For a flat channel wall oriented at an angle θ with respect to an incoming traveling SAW, the spacing is given by

$$s ( θ ) = {λ}_{l} sin ( θ ) csc ( θ - {sin}^{- 1} ( \frac{{c}_{l}}{{c}_{s}} sin θ ) ) , \qquad Equation ( S16 )$$

where cₗ is the sound speed in the liquid, cₛ is the sound speed on the substrate and λₗ is the acoustic wavelength in the liquid. The pattern spacings in the experimental images described with respect to FIG. 4B is in accordance with this prediction.

For continuous throughput-based micromanipulation on a microfluidic device, particles may be sorted into a usable number of outlets. In this case it may be useful to have a small number of particle trapping positions in the microchannel. It can be seen with respect to FIGS. 4A-4B and Equation S(16) above that if the channel is larger than the value of s(θ), then there will be multiple pressure maxima along the direction of the SAW propagation. However, if a microchannel that is smaller than this is used, such as in the case of common piezoelectric materials and water, this equates to less than approximately half of the SAW wavelength. Accordingly, the particles will be focused at only one or two (max) locations. In the case of dense particles, these will be focused at the channel edges, whereas particles that are less dense than the fluid media will be focused towards the channel middle. FIG. 22 shows the acoustic pressure distribution in microfluidic channels over the full range of possible channel orientations with a SAW wavelength equal to half the channel width. More particularly, FIG. 22 shows the pressure distribution in a microfluidic channel with a width half of the SAW wavelength for channel orientations from 0° to 180°. In this example embodiment, with a channel width that is narrower than the SAW wavelength, particles will migrate to the left and right of the channel regardless of channel orientation. In the coordinate system shown in FIG. 22, a 90° orientation corresponds to a SAW travelling down the long axis of the channel, whereas a 0° and 180° orientation corresponds to a SAW coming from the left and the right of the channel. As illustrated dense particles (for which the arrow plots overlaid represent force vectors) will move to either side of the channel for all channel wall orientations with respect to the incoming SAW. Particles that are substantially less dense than the fluid media will migrate toward a single position towards the channel middle, corresponding to the highest pressure condition.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A microfluidic device for acoustic particle manipulation, comprising:
a substrate having a substrate surface;
a microfluidic channel provided on the substrate surface, wherein the microfluidic channel is configured to form a fluid pathway for allowing a fluid sample comprising particles to flow along the microfluidic channel; and
a single transducer provided on the substrate for producing an acoustic travelling wave that propagates on the substrate surface towards an interaction region associated with the microfluidic channel as the fluid sample is flowing through the microfluidic channel,
wherein the microfluidic channel comprises at least three channel portions having three orientations, respectively, that are different from each other with respect to a direction of the propagation path of the travelling acoustic wave in the interaction region, the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

2. The device of claim 1, wherein one of the at least three channel portions comprises an orientation having an angle which is non-parallel and non-perpendicular with respect to the direction of the propagation path of the travelling acoustic wave.

3. The device of claim 1, wherein one or more of the at least three channel portions comprise an orientation with a flat surface.

4. The device of claim 1, wherein one or more of the at least three channel portions comprise an orientation with a curved surface.

5. The device of claim 4, wherein a curvature of the curved surface is configured based on a desired periodicity of the acoustic force fields.

6. The device of claim 1, wherein the at least three channel portions comprise a first channel portion, the first channel portion is a channel wall of the microfluidic channel.

7. The device of claim 1, wherein the at least three channel portions comprise a second channel portion, the second channel portion is a sub-microchannel structure extending from a channel wall of the microfluidic channel, wherein a surface of the sub-microchannel structure is arranged to produce fluid wavefronts based on substrate-propagated acoustic waves such that the fluid wavefronts and subsequent substrate-propagated acoustic waves interfere with one another to generate periodic acoustic force fields in the fluid sample for manipulating the particles.

8. The device of claim 7, wherein the sub-microchannel structure is a micropillar.

9. The device of claim 1, wherein the particle manipulation comprises particle patterning.

10. The device of claim 1, wherein the substrate comprises a piezoelectric substrate.

11. The device of claim 1, wherein the transducer is an interdigital transducer (IDT).

12. The device of claim 1, wherein the acoustic travelling wave comprises a surface acoustic wave (SAW).

13. The device of claim 1, wherein the transducer is arranged on the substrate surface at predetermined distance from the microfluidic channel.

14. A method of forming a microfluidic device for acoustic particle manipulation, the method comprising:
providing a substrate having a substrate surface;
providing a microfluidic channel on the substrate surface, wherein the microfluidic channel is configured to form a fluid pathway for allowing a fluid sample comprising particles to flow along the microfluidic channel; and
providing a single transducer on the substrate for producing an acoustic travelling wave that propagates on the substrate surface towards an interaction region associated with the microfluidic channel as the fluid sample is flowing through the microfluidic channel,
wherein the microfluidic channel comprises at least three channel portions having three orientations, respectively, that are different from each other with respect to a direction of the propagation path of the travelling acoustic wave in the interaction region, wherein the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles.

15. The method of claim 14, wherein one of the at least three channel portions comprises an orientation having an angle which is non-parallel and non-perpendicular with respect to the direction of the propagation path of the travelling acoustic wave.

16. The method of claim 14, wherein one or more of the at least three channel portions comprise an orientation with a flat surface.

17. The method of claim 14, wherein one or more of the at least three channel portions comprise an orientation with a curved surface.

18. The method of claim 17, wherein a curvature of the curved surface is configured based on a desired periodicity of the acoustic force fields.

19. The method of claim 14, wherein the at least three channel portions comprise a first channel portion, the first channel portion is a channel wall of the microfluidic channel.

20. The method of claim 14, wherein the at least three channel portions comprise a second channel portion, the second channel portion is a sub-microchannel structure extending from a channel wall of the microfluidic channel, wherein a surface of the sub-microchannel structure is arranged to produce fluid wavefronts based on substrate-propagated acoustic waves such that the fluid wavefronts and subsequent substrate-propagated acoustic waves interfere with one another to generate periodic acoustic force fields in the fluid sample for manipulating the particles.

21. The method of claim 21, wherein the sub-microchannel structure is a micropillar.

22. The method of claim 14, wherein the substrate comprises a piezoelectric substrate.

23. The method of claim 14, wherein the transducer is an interdigital transducer (IDT).

24. The method of claim 14, wherein the acoustic travelling wave comprises a surface acoustic wave (SAW).

25. The method of claim 14, wherein the transducer is arranged on the substrate surface at predetermined distance from the microfluidic channel.

26. A method of manipulating particles in a fluid sample based on an acoustic travelling wave using a microfluidic device for acoustic particle manipulation comprising a microfluidic channel provided on a substrate surface, wherein the microfluidic channel is configured to form a fluid pathway for allowing a fluid sample comprising particles to flow along the microfluidic channel; and a single transducer provided on the substrate for producing an acoustic travelling wave that propagates on the substrate surface towards an interaction region associated with the microfluidic channel as the fluid sample is flowing through the microfluidic channel, wherein the microfluidic channel comprises at least three channel portions having three orientations, respectively, that are different from each other with respect to a direction of the propagation path of the travelling acoustic wave in the interaction region, the at least three channel portions are arranged to produce fluid wavefronts based on substrate-propagated acoustic waves such that the fluid wavefronts and subsequent substrate-propagated acoustic wavefronts interfere with one another to generate periodic acoustic force fields in the fluid sample for manipulating the particles, the method comprising:
flowing the fluid sample comprising particles through the microfluidic channel of the microfluidic device to manipulate the fluid sample, including the particles therein;
generating an acoustic travelling wave using the single transducer that propagates on the substrate surface towards an interaction region of the microfluidic channel as the fluid sample flows through the microfluidic channel such that the at least three channel portions produce fluid wavefronts based on substrate-propagated acoustic waves such that the fluid wavefronts and subsequent substrate-propagated acoustic wavefronts interfere with one another to generate periodic acoustic force fields in the fluid sample; and
patterning the particles based on the periodic acoustic force fields in the interaction region of the microfluidic channel.
